(19) United States
(12) Patent Application Publication
(10) Pub. No.: US 2024/0276420 A1
(43) Pub. Date: Aug. 15, 2024

(54) POSITIONING REFERENCE UNIT INFORMATION NETWORKS

(71) Applicant: QUALCOMM Incorporated, San Diego, CA (US)

(72) Inventors: Mohammed Ali Mohammed HIRZALLAH, San Diego, CA (US); Marwen ZORGUI, San Diego, CA (US); Ahmed ELSHAFIE, San Diego, CA (US)

(21) Appl. No.: 18/169,837

(22) Filed: Feb. 15, 2023

(51) Int. Cl. H04W 64/00

(52) U.S. Cl. CPC H04W 64/00

(57) ABSTRACT

A wireless device may receive a set of positioning signals from at least one of a user equipment (UE), a first network node, or a positioning reference unit (PRU). The wireless device may measure the set of positioning signals. The wireless device may transmit, for the first network node or a second network node, a PRU label assistance report. The PRU label assistance report may include a set of positioning measurements based on the measured set of positioning signals The PRU label assistance report may include PRU assistance information associated with measuring the set of positioning signals. The wireless device may include a PRU. The PRU may be a UE or a mobile TRP having a known and fixed location while the PRU receives the positioning signals. The positioning signals may include at least one of a positioning reference signal (PRS) or a sounding reference signal (SRS).

### TECHNICAL FIELD

The present disclosure relates generally to communication systems, and more particularly, to a positioning system utilizing positioning reference units (PRUs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a positioning reference unit (PRU). The apparatus may receive a set of positioning signals from at least one of a user equipment (UE), a first network node, or a second PRU. The apparatus may measure the set of positioning signals. The apparatus may transmit, for the first network node or a second network node, a PRU label assistance report. The PRU label assistance report may include a set of positioning measurements based on the measured set of positioning signals. The PRU label assistance report may include PRU assistance information associated with measuring the set of positioning signals. The apparatus may transmit a second set of positioning signals to at least one of the UE, the first network node, or a second PRU. The apparatus may transmit, for at least one the first network node or the second network node, a second PRU assistance information associated with the second set of positioning signals. The PRU label assistance report may include the second PRU assistance information associated with the second set of positioning signals.

In an aspect of the disclosure, a method, a computer-readable medium, and an apparatus are provided. The apparatus may include a UE. The apparatus may transmit a set of sounding reference signals (SRSs) for a PRU. The apparatus may receive, from a network node, a PRU label assistance report. The PRU label assistance report may include a set of positioning measurements based on the set of SRSs. The PRU label assistance report may include PRU assistance information associated with the set of positioning measurements.

In an aspect of the disclosure, a method, a computer-readable medium, and an apparatus are provided. The apparatus may include a first network node. The apparatus may transmit a set of positioning reference signals (PRSs) for a PRU. The apparatus may receive, from a second network node, a PRU label assistance report. The PRU label assistance report may include a set of positioning measurements based on the set of PRSs. The PRU label assistance report may include PRU assistance information associated with the set of positioning measurements.

In an aspect of the disclosure, a method, a computer-readable medium, and an apparatus are provided. The apparatus may include a network node. The network node may include a location management function (LMF). The apparatus may transmit a request for a PRU label assistance report to a PRU associated with a set of positioning signals transmitted or received with the PRU. The apparatus may receive the PRU label assistance report including a set of PRU assistance information associated with the set of positioning signals.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of a positioning reference unit (PRU) configured to communicate positioning signals with other wireless devices, such as another PRU, a transmission reception point (TRP), a UE, or a location management function (LMF).

FIG. 6 is a connection flow diagram illustrating an example of a set of UEs/PRUs and a set of PRUs configured to perform positioning, in accordance with various aspects of the present disclosure.

FIG. 7 is a connection flow diagram illustrating an example of a set of network nodes/PRUs and a set of PRUs configured to perform positioning, in accordance with various aspects of the present disclosure.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a flowchart of a method of wireless communication.

FIG. 17 is a diagram illustrating an example of a hardware implementation for an example apparatus and/or network entity.

FIG. 18 is a diagram illustrating an example of a hardware implementation for an example network entity.

FIG. 19 is a diagram illustrating an example of a hardware implementation for an example network entity.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

A user equipment (UE) may be configured to perform positioning with a network node, such as a transmission reception point (TRP) of a base station. The UE may transmit a set of sounding reference signals (SRSs) to the network node for the network node to measure, and the network node may transmit a set of positioning reference signals (PRSs) for the UE to measure. The measurements may be used to calculate a position of the UE relative to one or more network nodes with known locations. For example, the UE may measure a round-trip-time (RTT) between a transmission of an SRS from the UE to a network node and a transmission of a PRS from the network node back to the UE to calculate the distance between the UE and the network node. The UE may triangulate its position by calculating its distance from two or more network nodes with known locations.

An efficient positioning model, such as a positioning model trained using artificial intelligence machine learning (AIML), may be used to perform positioning in a more efficient way. For example, the positioning model may be trained using a set of inputs (e.g., measurements of a set of reference signals (RSs) from a transmitting wireless device, such as a base station, an orientation of an antenna, a network synchronization error) and a set of expected labels (e.g., a location of a receiving wireless device that receives a set of RSs, an angle of arrival (AoA) of a set of RSs received by the receiving wireless device). After the positioning model has been trained, the positioning model may be used to calculate positioning information, such as a location of a receiving wireless device or an intermediate measurement that may be used to calculate the location of the receiving wireless device (e.g., an AoA, a reference signal time difference (RSTD), a line-of-sight (LOS) identification) based on measurements of a set of RSs. However, obtaining accurate data or labels to train a positioning model may be difficult, as UEs or TRPs may not be configured to share such assistance information with other wireless devices. The other wireless devices may be distributed by a different UE vendor or a different network (NW) operator, and hence may not have permission to access such assistance data.

A positioning reference unit (PRU) may be configured to emulate either a UE or a network node when performing positioning, such that the PRU may function as a network node when communicating with a UE (e.g., by transmitting a set of PRSs to the UE and by receiving/measuring a set of SRSs from the UE), and may function as a UE when communicating with a network node (e.g., by transmitting a set of SRSs to the network node and by receiving/measuring a set of PRSs from the network node). The PRU may be leveraged by UEs, network nodes, and/or other PRUs to generate positioning information, such as positioning measurements or location information, and may share PRU label assistance reports using one or more protocols to collect and share data for training positioning models, including input data and output labels for training. A label may be referred to as a calculated expected result from a set of inputs, which may be used for training a positioning model. The PRU may be configured to function as a UE that is fixed in place in a known location while performing positioning, and as a mobile network node that is fixed in place in a known location while performing positioning, to help enrich and diversify training data for both uplink (UL) and downlink (DL) inputs and labels for training a positioning model. The PRU label assistance reports shared by the PRU may include the PRU's private location and proprietary information, such as the PRU's location, beam angle information of transmitted or received positioning signals, antenna information for transmitting or receiving positioning signals, or PRU sensor information. The information in the PRU label assistance report may be used to assist a UE or a network node in obtaining labels for training a positioning model without a network vendor, a network operator, or a UE vendor disclosing proprietary information for their equipment or infrastructure.

A wireless device (e.g., a PRU configured to emulate a UE or a network node when performing positioning) may receive a set of positioning signals from at least one of a UE, a first network node, or a PRU. The wireless device may measure the set of positioning signals. The wireless device may transmit, for the first network node or a second network node, a PRU label assistance report. The PRU label assistance report may include a set of positioning measurements based on the measured set of positioning signals. The PRU label assistance report may include PRU assistance information associated with measuring the set of positioning signals. The second network node may transmit a request for a PRU label assistance report to the wireless device. The second network node may receive the PRU label assistance report. The second network node may transmit at least a portion of the received PRU label assistance report to a UE or a network node to assist in training a positioning model, or to assist in utilizing a positioning model. A UE may transmit a set of sounding reference signals (SRSs) for the wireless device. The UE may receive, from the first network node or the second network node, a PRU label assistance report. The first network node may transmit a set of positioning reference signals (PRSs) for the wireless device. The first network node may receive, from the second network node or the wireless device, a PRU label assistance report.

Various aspects relate generally to sharing PRU label assistance report with wireless devices, such as PRUs, UEs, and/or network nodes. Some aspects more specifically relate to using the PRU label assistance report data collected by one or more PRUs to train one or more positioning models. The PRU may communicate with wireless device via a long term evolution (LTE) positioning protocol (LPP) annex (LPPa) message. The PRU may communicate with a wireless device via a new radio (NR) positioning protocol (NRPP) annex (NRPPa) message. As such, a PRU may collect assistance information, such as a location of the PRU, a beam angle, an antenna delay, or a group delay, and may transmit the assistance information to an entity that trains the positioning model for accurate positioning.

Particular aspects of the subject matter described in this disclosure can be implemented to realize one or more of the following potential advantages. In some examples, by configuring a PRU to share PRU assistance information in a PRU label assistance report, positioning wireless devices, such as a UE or a network node, may collect training data for training a positioning model, or for using a positioning model to calculate a position of a wireless device, or to calculate an intermediate value (e.g., an AoA, a RSTD) that may be used to calculate a position of a wireless device. In some examples, by configuring a PRU to share PRU assistance information in a PRU label assistance report, a UE or a network node may collect training data for training a positioning model while maintaining privacy information and proprietary information of a UE or a network node using infrastructure that supports PRU communications.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

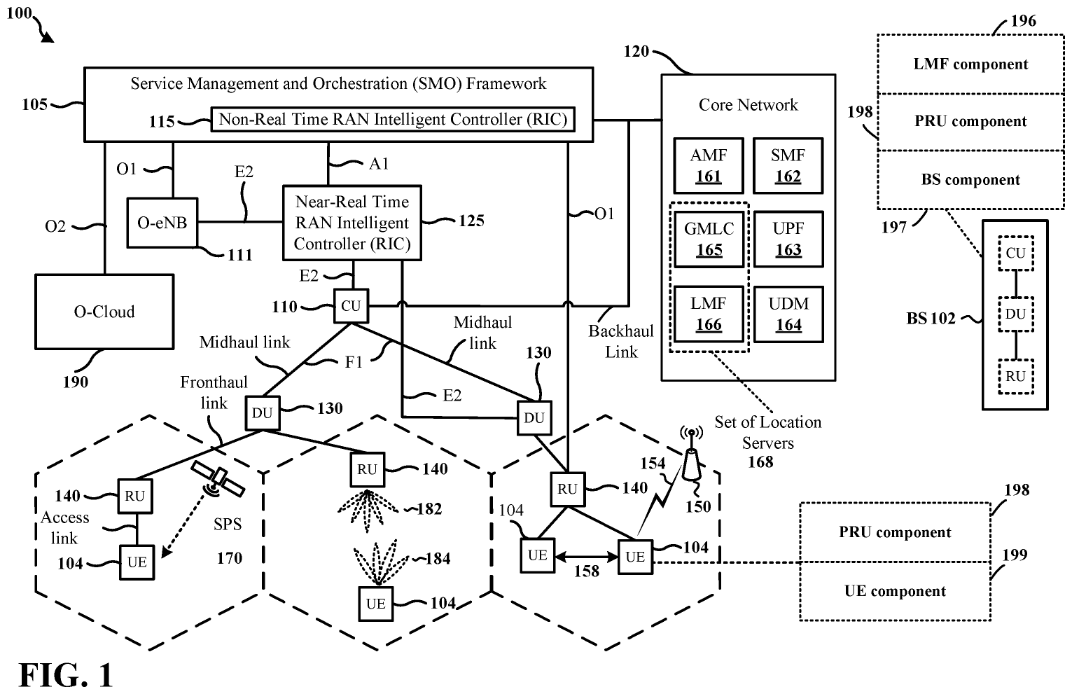

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell identifier (ID) (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 or the base station 102 may have a PRU component 198 that may be configured to receive a set of positioning signals from at least one of a UE, a first network node, or a PRU. The PRU component 198 may be configured to measure the set of positioning signals. The PRU component 198 may be configured to transmit, for the first network node or a second network node, a PRU label assistance report. The PRU label assistance report may include a set of positioning measurements based on the measured set of positioning signals. The PRU label assistance report may include PRU assistance information associated with measuring the set of positioning signals. The PRU component 198 may be configured to transmit a second set of positioning signals to at least one of the UE, the first network node, or the PRU. The PRU component 198 may be configured to transmit, for at least one the first network node or the second network node, a second PRU assistance information associated with the second set of positioning signals. The PRU label assistance report may include the second PRU assistance information associated with the second set of positioning signals. The first set of positioning signals may be a set of SRSs or a set of PRSs. The second set of positioning signals may be a set of SRSs or a set of PRSs. The second network node may be an LMF, for example the LMF 166.

In certain aspects, the UE 104 may have a UE component 199 that may be configured to transmit a set of sounding reference signals (SRSs) for a PRU. The UE component 199 may be configured to receive, from a network node, a PRU label assistance report. The PRU label assistance report may include a set of positioning measurements based on the set of SRSs. The PRU label assistance report may include PRU assistance information associated with the set of positioning measurements. The UE component 199 may be configured to receive a set of PRSs from the PRU. The UE component 199 may be configured to measure the set of PRSs. The UE component 199 may be configured to calculate a position of the UE based on the measured set of PRSs and the set of positioning measurements. The PRU label assistance report may include PRU assistance information associated with the set of PRSs from the PRU.

In certain aspects, the base station 102 may have a BS component 197 that may be configured to transmit a set of positioning reference signals (PRSs) for a PRU. The BS component 197 may be configured to receive, from a second network node, such as the LMF 166, a PRU label assistance report. The PRU label assistance report may include a set of positioning measurements based on the set of PRSs. The PRU label assistance report may include PRU assistance information associated with the set of positioning measurements.

In certain aspects, the base station 102 may have an LMF component 196 that may be configured to transmit a request for a PRU label assistance report to a PRU associated with a set of positioning signals transmitted or received with the PRU. The LMF component 196 may receive the PRU label assistance report including a set of PRU assistance information associated with the set of positioning signals.

Using one or more of the PRU component 198, the UE component 199, the BS component 197, and/or the LMF component 196, a PRU may be configured to share a PRU label assistance report with PRU assistance information associated with a set of positioning signals, such as the location of the PRU, beam angle information, antenna orientation information, or sensor information, to assist a UE or a base station in labeling for training a positioning model, for example by using artificial intelligence machine learning (AIML) techniques to train a model using a set of inputs and a set of expected labels. Such sharing of PRU assistance information may be performed without a network vendor, a network operator, a UE vendor, or a UE operator to disclose proprietary information for their equipment, infrastructure, or location information.

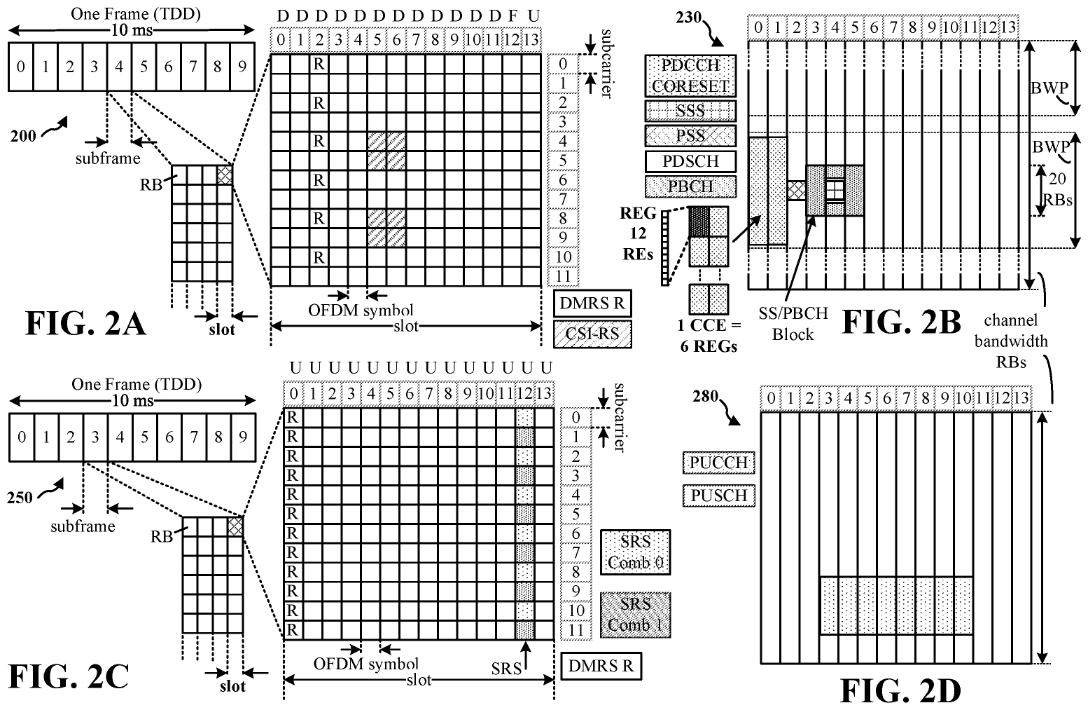

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

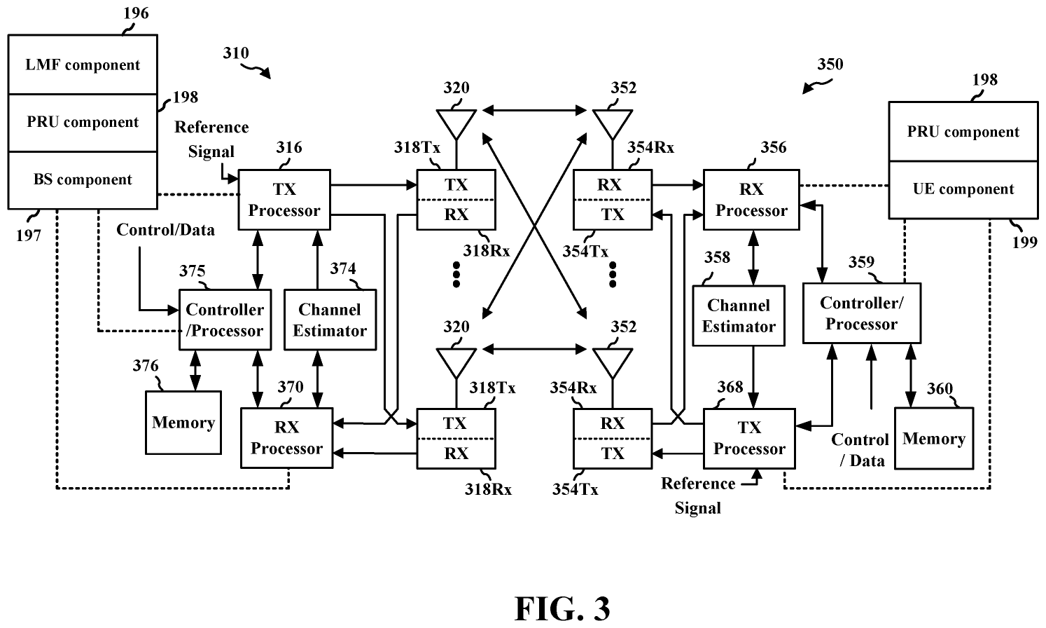

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the PRU component 198 of FIG. 1.

At least one of the TX processor 368, the RX processor 356, and the controller/processor 359 may be configured to perform aspects in connection with the UE component 199 of FIG. 1.

At least one of the TX processor 316, the RX processor 370, and the controller/processor 375 may be configured to perform aspects in connection with the PRU component 198 of FIG. 1.

At least one of the TX processor 316, the RX processor 370, and the controller/processor 375 may be configured to perform aspects in connection with the BS component 197 of FIG. 1.

At least one of the TX processor 316, the RX processor 370, and the controller/processor 375 may be configured to perform aspects in connection with the LMF component 196 of FIG. 1.

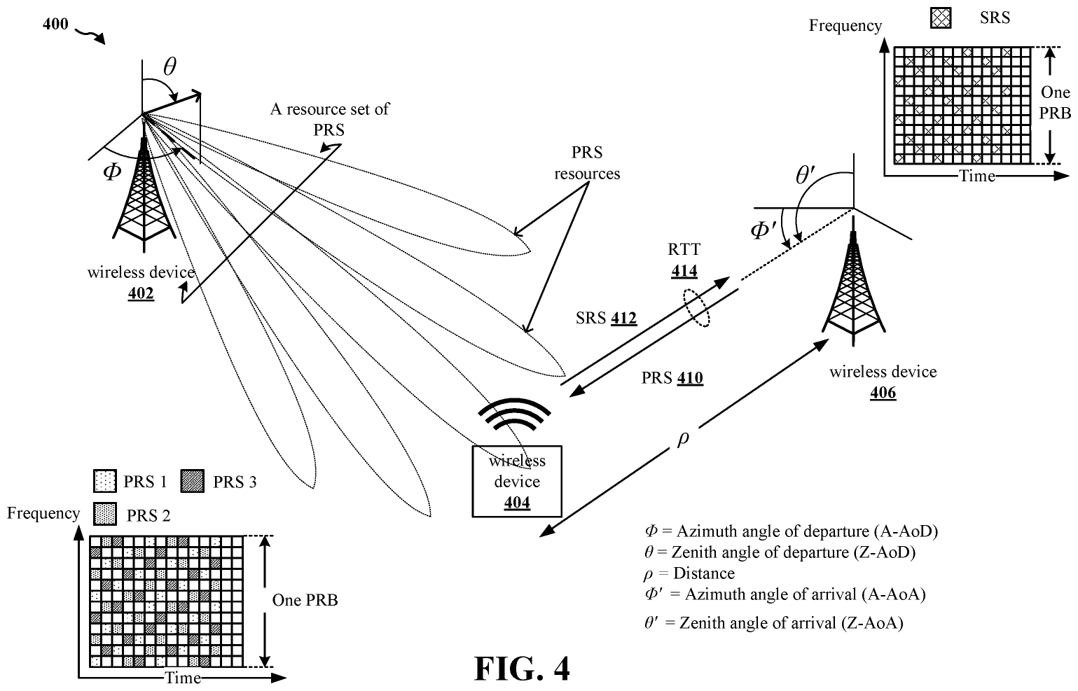

FIG. 4 is a diagram 400 illustrating an example of positioning based on reference signal measurements. The wireless device 402 may be a UE, a base station, or a positioning reference unit (PRU). The wireless device 404 may be a UE, a base station, or a PRU. The wireless device 406 may be a UE, a base station, or a PRU. The wireless device 402 may be referred to as a positioning target wireless device, whose location may be calculated based on measurements of one or more reference signals. The wireless device 404 and the wireless device 406 may be referred to as positioning neighbor wireless devices, whose locations may be known, which may be used to calculate the location of the wireless device 402. The wireless device 404 may transmit SRS 412 at time T_{SRS_TX} to the wireless device 406. The wireless device 404 may receive positioning reference signals (PRS) 410 at time T_{PRS_RX} from the wireless device 406. The SRS 412 may be an UL-SRS. The PRS 410 may be a DL-PRS. In some aspects, the wireless device 402 may be a TRP and the wireless device 406 may be a TRP, which may be both configured to transmit DL-PRS to the wireless device 404. The wireless device 404 may be a UE configured to transmit UL-SRS to the wireless device 402 and the wireless device 406.

The wireless device 406 may receive the SRS 412 at time T_{SRS_RX} from the wireless device 404 and transmit the PRS 410 at time T_{PRS_TX} to the wireless device 404. The wireless device 404 may receive the PRS 410 before transmitting the SRS 412. The wireless device 404 may transmit the SRS 412 before receiving the PRS 410. The wireless device 404 may transmit the SRS 412 in response to receiving the PRS 410. The wireless device 406 may transmit the PRS 410 in response to receiving the SRS 412. A positioning server (e.g., location server(s) 168), the wireless device 404, or the wireless device 406 may determine the round-trip-time (RTT) 414 based on ∥T_{SRS_RX}−T_{PRS_TX}|−|T_{SRS_TX}−T_{PRS_RX}∥. Multi-RTT positioning may make use of the Rx-Tx time difference measurements (i.e., |T_{SRS_TX}−T_{PRS_RX}|) and PRS reference signal received power (RSRP) (PRS-RSRP) of PRS signals received from multiple wireless devices, such as the wireless device 402 and the wireless device 406, which are measured by the wireless device 404, and the measured Rx-Tx time difference measurements (i.e., |T_{SRS_RX}−T_{PRS_TX}|) and SRS-RSRP at multiple wireless devices, such as at the wireless device 402 and at the wireless device 406 of SRS transmitted from wireless device 404. The wireless device 404 may measure the Rx-Tx time difference measurements, and/or PRS-RSRP of the received signals, using assistance data received from the positioning server, the wireless device 402, and/or the wireless device 406. The wireless device 402 and the wireless device 406 may measure the Rx-Tx time difference measurements, and/or SRS-RSRP of the received signals, using assistance data received from the positioning server. The measurements may be used at the positioning server or the wireless device 404 to determine the RTT, which may be used to estimate the location of the wireless device 404. Other methods are possible for determining the RTT, such as for example using time-difference of arrival (TDOA) measurements, such as DL-TDOA and/or UL-TDOA measurements.

DL-AoD positioning may make use of the measured PRS-RSRP of signals transmitted from multiple wireless devices, such as the wireless device 402 and the wireless device 406, and received at the wireless device 404. The AoD positioning may also be referred to as DL-AoD positioning where the PRS are DL signals. The wireless device 404 may measure the PRS-RSRP of the received signals using assistance data received from the positioning server, and the resulting measurements may be used along with the azimuth angle of departure (A-AoD), the zenith angle of departure (Z-AoD), and other configuration information to locate the wireless device 404 in relation to the neighboring wireless devices that transmitted the PRS, such as the wireless device 402 and the wireless device 406.

DL-TDOA positioning may make use of the DL reference signal time difference (RSTD), and/or PRS-RSRP of signals received from multiple wireless devices, such as the wireless device 402 and the wireless device 406, at the wireless device 404. The wireless device 404 may measure the RSTD, and/or the PRS-RSRP, of the received PRS signals using assistance data received from the positioning server, and the resulting measurements may be used along with other configuration information to locate the wireless device 404 in relation to the neighboring wireless devices that transmitted the PRS, such as the wireless device 402 and the wireless device 406.

UL-TDOA positioning may make use of the UL relative time of arrival (RTOA), and/or SRS-RSRP, at multiple wireless devices, such as the wireless device 402 and the wireless device 406, of signals transmitted from the wireless device 404. The wireless devices, such as the wireless device 402 and the wireless device 406, may measure the RTOA, and/or the SRS-RSRP, of the received signals using assistance data received from the positioning server, and the resulting measurements may be used along with other configuration information to estimate the location of the wireless device 404.

UL-AoA positioning may make use of the measured azimuth angle of arrival (A-AoA) and zenith angle of arrival (Z-AoA) at multiple wireless devices, such as the wireless device 402 and the wireless device 406, of signals transmitted from the wireless device 404. The wireless device 402 and the wireless device 406 may measure the A-AoA and the Z-AoA of the received signals using assistance data received from the positioning server, and the resulting measurements may be used along with other configuration information to estimate the location of the wireless device 404.

Additional positioning methods may be used for estimating the location of the wireless device 404, such as for example, UL-AoD and/or DL-AoA at the wireless device 404. Note that data/measurements from various technologies may be combined in various ways to increase accuracy, to determine and/or to enhance certainty, to supplement/complement measurements, and/or to substitute/provide for missing information.

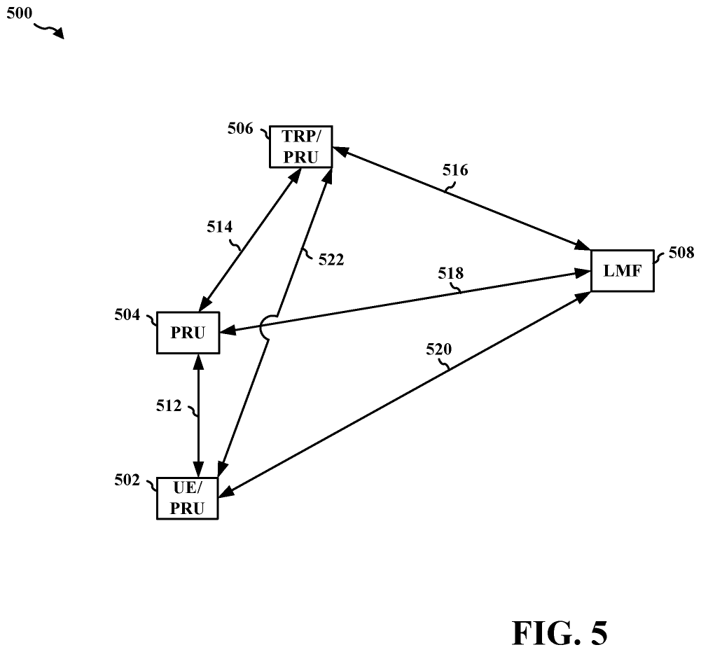

FIG. 5 is a diagram 500 illustrating an example of a PRU 504 configured to communicate positioning signals with a TRP/PRU 506, a UE/PRU 502, and a LMF 508. In one aspect, the PRU 504 may be configured to mimic a UE when communicating with the TRP/PRU 506, and may be configured to mimic a TRP/PRU 506 when communicating with the UE/PRU 502. In another aspect, the PRU 504 may be configured to mimic a UE when performing positioning with the TRP/PRU 506 via the signals 514, and the PRU 504 may be configured to mimic a TRP when performing positioning with the UE/PRU 502 via the signals 512. The PRU 504 may be configured to transmit a set of SRSs to the TRP/PRU 506, and may be configured to receive and measure a set of PRSs from the TRP/PRU 506. The PRU 504 may be configured to transmit a set of PRSs to the UE/PRU 502, and may be configured to receive and measure a set of SRSs from the UE/PRU 502. The UE/PRU 502 and the TRP/PRU 506 may be configured to perform positioning with one another via the signals 522. The LMF 508 may be configured to coordinate positioning with the UE/PRU 502 via the signals 520, coordinate positioning with the PRU 504 via the signals 518, and coordinate positioning with the TRP/PRU 506 via the signals 516. The UE/PRU 502 may be configured to communicate with the LMF 508 via the LPPa protocol (using LPPa messages). The TRP/PRU 506 may be configured to communicate with the LMF 508 via the NRPPa protocol (using NRPPa messages). The PRU 504 may be configured to communicate with the LMF 508 using either the LPPa protocol, or the NRPPa protocol, as appropriate. For example, the PRU 504 may be configured to share PRU label assistance reports based on SRS measurements with the LMF 508 via the NRPPa protocol, and may be configured to share PRU label assistance reports based on PRS measurements with the LMF 508 via the LPPa protocol.

While one TRP, one PRU, and one UE are shown in diagram 500, a plurality of TRPs, a plurality of PRUS, and/or a plurality of UEs may be configured to perform positioning with one another in other aspects of the present disclosure. For example, the UE/PRU 502 may be configured to perform positioning with a plurality of TRPs, with a plurality of PRUs, or with both the TRP/PRU 506 and the PRU 504. In another example, the PRU 504 may be configured to perform positioning with a plurality of TRPs and/or a plurality of UEs. The UE/PRU 502 may be a UE, a PRU, or a PRU configured to operate as a UE when performing positioning with another wireless device. The TRP/PRU 506 may be a TRP, a PRU, or a PRU configured to operate as a TRP when performing positioning with another wireless device.

A PRU, such as the PRU 504, the UE/PRU 502, and/or the TRP/PRU 506, may be configured to share a PRU label assistance report with the LMF 508 to train a positioning model with measurement data and labels, or to use a positioning model to calculate a result using measurement data. The LMF 508 may be configured to share at least a portion of a received PRU label assistance report with a UE or a network node so that the UE or network node may train or use the AIML model. A wireless device configured to train a positioning model may use measurement data and label data to train a positioning model to calculate a result using the measurement data. In one aspect, a first wireless device may train a positioning model to calculate a target location of a second wireless device. The first wireless device may input measurements, such as a channel impulse response (CIR) of a measured PRS or a CIR of a measured SRS, and a direct label such as a known location of the second wireless device, to the positioning model to train the positioning model to calculate a location. In another aspect, a first wireless device may train a positioning model to calculate an intermediate measurement that may be used to calculate a target location of a second wireless device. The first wireless device may input measurements, such as a CIR of a measured PRS or a CIR of a measured SRS, and an intermediate label such as a known positioning timing, a known angle of arrival (AoA) of a positioning signal, a known angle of departure (AoD) of a positioning signal, or a line-of-sight (LOS) path with the second wireless device, to the positioning model to train the positioning model to calculate an intermediate measurement that may be used to calculate the position of the second wireless device. Once the positioning model is trained, the first wireless device may calculate the direct result or the intermediate result based on one or more input measurements. The first wireless device may use the intermediate result to calculate the target location of the second wireless device, for example by using a Chans algorithm, a Kalman Filter (KF) algorithm, or some other algorithm that uses the intermediate result to calculate a target location.

The PRU 504 may collect a variety of data to train a positioning model, or to use a positioning model. In some aspects, the PRU may collect DL measurements and/or UL measurements of positioning signals, such as an SRS signal transmitted as the signals 512 from the UE/PRU 502, or a PRS signal transmitted as the signals 514 from the TRP/PRU 506. The training data may include reference signal measurements, clean labels (e.g., labels having a degree of accuracy above a threshold level), noisy labels (e.g., labels having a degree of accuracy below a threshold level), and/or PRU assistance information (e.g., PRU location, BWP, number of TRPs, beam information, beam angle information, PRS configuration, SRS configuration).

A PRU may have one or more high accuracy sensors that may be used to calculate the position of the PRU. For example, the PRU may have a high-accuracy GPS, GNSS device, LIDAR sensor, or other sensors that may be used to calculate the position of the PRU with a high degree of accuracy. A position calculated using such high-accuracy devices may be used as a label to train a positioning model. The PRU may calculate a ground truth by collecting other PRU assistance information associated with a positioning signal, such as a time of arrival (ToA), a reference signal time difference (RSTD), a line-of-sight (LOS) identification, or a non-line-of-sight (NLOS) identification). The PRU, such as the PRU 504 the UE/PRU 502, or the TRP/PRU 506, may be configured to share some private, or proprietary, information, such as its private location, beam angle information, antenna orientation, or other sensor information, to help a UE or a network node collect accurate labels for training a positioning model.

A wireless device (e.g., a PRU configured to emulate a UE or a network node when performing positioning) may receive a set of positioning signals from at least one of a UE, a first network node, or a second PRU. The wireless device may measure the set of positioning signals. The wireless device may transmit, for the first network node or a second network node, a PRU label assistance report. The PRU label assistance report may include a set of positioning measurements based on the measured set of positioning signals. The PRU label assistance report may include PRU assistance information associated with measuring the set of positioning signals. The wireless device may transmit a second set of positioning signals to at least one of the UE, the first network node, or a second PRU. The apparatus may transmit, for at least one the first network node or the second network node, a second PRU assistance information associated with the second set of positioning signals. The PRU label assistance report may include the second PRU assistance information associated with the second set of positioning signals. The second network node may transmit a request for a PRU label assistance report to the wireless device. The second network node may receive the PRU label assistance report. The second network node may transmit at least a portion of the received PRU label assistance report to a UE or a network node to assist in training a positioning model, or to assist in utilizing a positioning model. A UE may transmit a set of sounding reference signals (SRSs) for the wireless device. The UE may receive, from the first network node or the second network node, a PRU label assistance report. The first network node may transmit a set of positioning reference signals (PRSs) for the wireless device. The first network node may receive, from the second network node or the wireless device, a PRU label assistance report.

A PRU configured to share its PRU assistance data via a PRU label assistance report may enable a UE or a network node to collect training data. Such training data may be used to train a positioning model with direct labels or intermediate labels. By sharing PRU assistance data via a PRU label assistance report, the PRU may maintain privacy information and/or proprietary information of a deployed infrastructure while allowing a UE or a network node to collect training data from the PRU. Such a PRU may be equipped with high-accuracy sensors to obtain cleaner labels than other wireless devices, allowing such a PRU to be used specifically to train positioning models. In some aspects, a network TRP may be configured to not share a location of a TRP, or network-side beam angle information, or network synchronization and timing errors, which may limit the ability for a wireless device, such as a UE or a network node, to collect training data or labels for training a positioning model. A PRU, or a network TRP configured to share data like a PRU, may be used to collect training data without violating its configured specification. In some aspects, a UE or a TRP may be configured to share PRU label assistance report information via a chip that supports such PRU functionality.

A PRU label assistance report may include data that may be used to train a positioning model, such as a set of positioning measurements based on a measured set of positioning signals, a set of expected labels, and a set of PRU assistance information associated with measuring the set of positioning signals. A positioning measurement may be any measurement of a positioning signal, for example a PRS, an SRS, or a CSI-RS. The positioning measurement The expected labels may be clean or noisy labels. Clean labels may have a high degree of accuracy, for example a known location of a wireless device based on GPS coordinates, or a known LOS path between an antenna of a positioning target and an antenna of a positioning neighbor. Noisy labels may have a low degree of accuracy, for example a location of a wireless device based on a GNSS fix using a sensor in a noisy environment, or an estimated AoD or AoA of a beam between an antenna of a positioning target an antenna of a positioning neighbor. The set of PRU assistance information may include metrics associated with a set of positioning signals, for example, BWP, number of TRPs, beam information, PRS configuration information, or SRS configuration information. The set of positioning measurements and the set of assistance information may be used as inputs to a positioning model, and the set of expected labels may be used to train the positioning model to calculate positioning results close to the expected labels using at least some of the inputs.

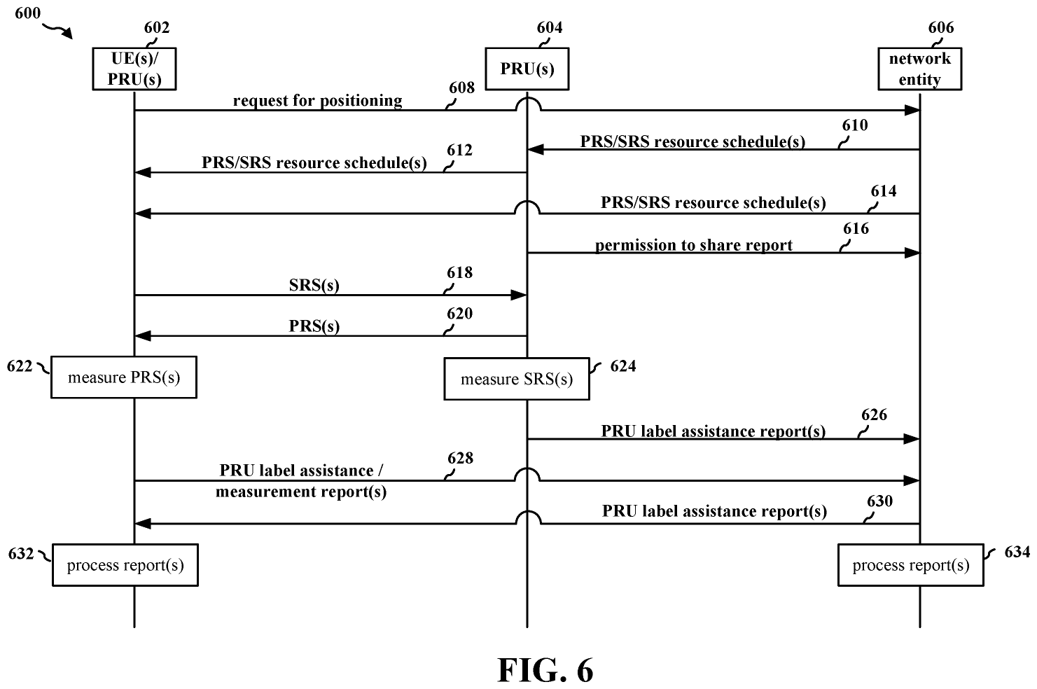

FIG. 6 is a connection flow diagram 600 illustrating an example of a set of UEs/PRUs 602 and a set of PRUs 604 configured to perform positioning with one another. The set of UEs/PRUs 602 may include at least one UE, may include at least one PRU, or may include at least one UE and at least one PRU. A UE of the set of UEs/PRUs 602 may not be configured to share a PRU label assistance report with other wireless devices, but may be configured to share measurement reports of measured positioning signals, such as measured PRSs. In some aspects, a PRU may be realized by a UE with a known location. In some aspects, a PRU may be realized by a mobile TRP with a known location. In some aspects, the set of UEs/PRUs 602 may include a PRU configured to emulate a UE during positioning. The network entity 606 may include an LMF. The network entity 606 may include a positioning server. In some aspects, the set of PRUs 604 may include the network entity 606, such that one of the set of PRUs 604 may coordinate positioning between the set of UEs/PRUs 602 and the set of PRUs 604.

UEs of the set of UEs/PRUs 602 and/or the network entity 606 may know the location of any of the PRUs of the set of PRUs 604 or the set of UEs/PRUs 602. For example, the network entity 606 may have a database of known locations of each of the set of PRUs 604. In some aspects, a PRU may calculate its location using positioning, or using other sensors/non-RF positioning methods (e.g., a GNSS fix using a high-accuracy GNSS or by traveling to a known location at a prearranged time) and may transmit its location to the network entity 606, which may update other wireless devices, such as the set of UEs/PRUs 602, of the location of the PRU. In other aspects, a PRU of the set of PRUs 604 may broadcast its calculated location to other wireless devices, such as the set of UEs/PRUs 602. In other aspects, the network entity 606 may perform positioning on a PRU of the set of PRUs 604, and may then update other wireless devices, such as UEs of the set of UEs/PRUs 602, of the location of the PRU.

At least one of the set of UEs/PRUs 602 may transmit a request 608 for positioning to the network entity 606. The network entity 606 may receive the request 608 for positioning. The request 608 may be transmitted as a part of assistance data exchange of LPPa protocol between the set of UEs/PRUs 602 and the network entity 606. In one aspect, the set of UEs/PRUs 602 may transmit an assistance exchange message to the network entity 606 including the request 608 for positioning. In one aspect, the set of UEs/PRUs 602 may transmit an LPPa message to the network entity 606 including the request 608 for positioning. The request 608 for positioning may request the network entity 606 to configure positioning between the set of UEs/PRUs 602 and the set of PRUs 604, for example to configure the set of SRSs 618 and/or to configure the set of PRSs 620.

The request 608 for positioning may include a request for a PRU to transmit a PRU label assistance report that may be shared with at least one of the set of UEs/PRUs 602. The request 608 for positioning may include an indication of information that may be included in the PRU label assistance report. The request 608 for positioning may include a request for PRU positioning measurements, for example a request for measurements of the set of SRSs by the set of PRUs 604, and/or a request for measurements of the set of PRSs by the set of UEs/PRUs 602. The request 608 for positioning may include a request for the network entity 606 to configure resources for positioning. In one aspect, the request 608 for positioning may include a request for the network entity 606 to configure SRS resources for the set of UEs/PRUs 602 to transmit the set of SRSs 618 to the set of PRUs 604 and for the set of PRUs 604 to receive the set of SRSs 618. In one aspect, the request 608 for positioning may include a request for the network entity 606 to configure PRS resources for the set of PRUS 604 to transmit the set of PRSs 620 to the set of UEs/PRUs 602 and for the set of UEs/PRUs 602 to receive the set of PRSs 620.

The request 608 for positioning may include a request for PRU assistance information. The PRU assistance information may include an indication of a location of at least one of the set of PRUs 604. The PRU assistance information may include an indication of a location of at least one of the PRUs of the set of UEs/PRUs 602. The PRU assistance information may include an indication of a beam angle associated with a set of positioning signals received or transmitted by the set of PRUs 604. In one aspect, the PRU assistance information may include a calculated angle of arrival (AoA) of the set of SRSs 618. In another aspect, the PRU assistance information may include a calculated angle of departure (AoD) of the set of PRSs 620. The PRU assistance information may include an indication of a beam angle associated with a set of positioning signals received or transmitted by PRUs of the set of UEs/PRUs 602. In one aspect, the PRU assistance information may include a calculated AoA of the set of PRSs 620 received by PRUs of the set of UEs/PRUs 602. In another aspect, the PRU assistance information may include a calculated AoA of the set of SRSs 618 transmitted by PRUs of the set of UEs/PRUs 602. The PRU assistance information may include an indication of an antenna orientation associated with the set of PRUs 604 transmitting or receiving a set of positioning signals. In one aspect, the PRU assistance information may include a set of orientations of a set of antennas of the set of PRUs 604 that receive the set of SRSs 618. In another aspect, the PRU assistance information may include a set of orientations of a set of antennas of the set of PRUs 604 that transmit the set of PRSs 620. The PRU assistance information may include an indication of an antenna orientation associated with PRUs of the set of UEs/PRUs 602 transmitting or receiving a set of positioning signals. In one aspect, the PRU assistance information may include a set of orientations of a set of antennas of PRUs of the set of UEs/PRUs 602 that receive the set of PRSs 620. In another aspect, the PRU assistance information may include a set of orientations of a set of antennas of PRUs of the set of UEs/PRUs 602 that transmit the set of SRSs 618. The PRU assistance information may include an indication of a group delay associated with the set of PRUs 604 measuring the set of SRSs 618. The PRU assistance information may include an indication of a group delay associated with PRUs of the set of UEs/PRUs 602 measuring the set of PRSs 620. The PRU assistance information may include an indication of a sensor measurement associated with the set of PRUs 604 measuring the set of SRSs 618. For example, an indication of a position calculated via a high-accuracy GNSS device, an indication of a position calculated via a high-accuracy LIDAR device, or an indication of a reference signal received power (RSRP) measured for the set of SRSs 618, or an indication of a round trip time (RTT) measured for the set of SRSs 618. The PRU assistance information may include an indication of a sensor measurement associated with PRUs of the set of UEs/PRUs 602 measuring the set of PRSs 620. The PRU assistance information may include an indication of a sensor type associated with at least one PRU of the set of PRUs 604. For example, an indication of a LIDAR sensor used, or an indication of a GPS device used. The PRU assistance information may include an indication of a sensor type associated with a PRU of the set of UEs/PRUs 602. The PRU assistance information may include an indication of a synchronization error associated with the set of PRUS 604 measuring the set of SRSs 618. The PRU assistance information may include an indication of a synchronization error associated with PRUs of the set of UEs/PRUs 602 measuring the set of PRSs 620. The PRU assistance information may include an indication of a Tx-Rx or Rx-Tx timing error associated with the set of PRUs 604 measuring the set of SRSs 618. The PRU assistance information may include an indication of a Tx-Rx or Rx-Tx timing error associated with PRUs of the set of UEs/PRUs 602 measuring the set of PRSs 620. The PRU assistance information may include an indication of a clock drift range associated with the set of PRUs 604 measuring the set of SRSs 618. The PRU assistance information may include an indication of a clock drift range associated with PRUs of the set of UEs/PRUs 602 measuring the set of PRSs 620.

In response to receiving the request 608 for positioning, the network entity 606 may transmit a set of PRS/SRS resource schedules 610 to the set of PRUs 604. The set of PRUs 604 may receive the set of PRS/SRS resource schedules 610. The set of PRS/SRS resource schedules 610 may configure the set of PRUs 604 to receive the set of SRSs 618. The set of PRS/SRS resource schedules 610 may configure the set of PRUs 604 to transmit the set of PRSs 620. The set of PRS/SRS resource schedules 610 may request the set of PRUs 604 to share a PRU label assistance report with the network entity 606. Such a request may indicate what types of PRU positioning measurements and/or PRU assistance information may be included in the PRU label assistance report. The set of PRS/SRS resource schedules 610 may request the set of PRUs 604 to share a permissibility/consent rule with the network entity 606. The network entity 606 may transmit the set of PRS/SRS resource schedules 610 via an NRPPa message. The network entity 606 may transmit the set of PRS/SRS resource schedules 610 as part of an NRPPa TRP information exchange and measurement exchange.

In some aspects, at least some of the set of PRUs 604 may configure a set of PRS/SRS resource schedules 612 based on the set of PRS/SRS resource schedules 610. For example, some of the set of PRUs 604 may be serving cells of the set of UEs/PRUs 602. The set of PRUs 604 may transmit the set of PRS/SRS resource schedules 612 to the set of UEs/PRUs 602. The set of UEs/PRUs 602 may receive the set of PRS/SRS resource schedules 612 from the set of PRUs 604. The set of PRS/SRS resource schedules 612 may configure the set of UEs/PRUs 602 to transmit the set of SRSs 618 to the set of PRUs 604. The set of PRS/SRS resource schedules 612 may configure the set of UEs/PRUs 602 to receive the set of PRSs 620 from the set of PRUs 604. The set of PRUs 604 may transmit the set of PRS/SRS resource schedules 612 as an RRC configuration.

In other aspects, the network entity 606 may directly configure the set of PRS/SRS resource schedules 614 for the set of UEs/PRUs 602. The network entity 606 may transmit the set of PRS/SRS resource schedules 614 to the set of UEs/PRUs 602. The set of UEs/PRUs 602 may receive the set of PRS/SRS resource schedules 614 from the network entity 606. The set of PRS/SRS resource schedules 614 may configure the set of UEs/PRUs 602 to transmit the set of SRSs 618 to the set of PRUs 604. The set of PRS/SRS resource schedules 614 may configure the set of UEs/PRUs 602 to receive the set of PRSs 620 from the set of PRUs 604. The network entity 606 may transmit the set of PRS/SRS resource schedules 614 as an RRC configuration.

In response to receiving, from the network entity 606, a request to share a PRU label assistance report with the network entity 606, the set of PRUs 604 may transmit an indication 616 of a permission to share a PRU label assistance report to the network entity 606. The network entity 606 may receive the indication 616 of the permission to share a PRU label assistance report. The indication 616 of the permission to share a PRU label assistance report may include a permissibility/consent rule to share a PRU label assistance report, PRU assistance information, and/or PRU positioning measurements with a set of wireless devices. The permissibility/consent rule may indicate a set of wireless devices that a PRU label assistance report may be shared with. In some aspects, the permissibility/consent rule may be open without specifying the UEs, network nodes, and/or PRUs that may obtain PRU positioning measurements, PRU assistance information, or a PRU label assistance report. In some aspects, the permissibility/consent rule may specify the UEs, network nodes, and/or PRUs that may obtain PRU positioning measurements, PRU assistance information, or a PRU label assistance report. In some aspects, the permissibility/consent rule may categorize a set of UEs and/or a set of PRUs based on their UE identifier (ID), UE vendor, and/or their UE chip vendor. For example, the permissibility/consent rule may include a list of UE identifiers (IDs). In some aspects, the permissibility/consent rule may categorize a set of network nodes and/or a set of PRUs based on their cell ID, TRP ID, network vendor and/or their network operator. In other words, the indication 616 of the permission to share the PRU label assistance report may include at least one of (a) a set of UE IDs associated with a set of UEs authorized to receive the PRU label assistance report, (b) an indication of a UE vendor associated with a first set of UEs authorized to receive the PRU label assistance report, (c) an indication of a UE chip vendor associated with a second set of UEs authorized to receive the PRU label assistance report, (d) a set of TRP IDs associated with TRPs authorized to receive the PRU label assistance report, (e) an indication of a NW operator associated with a first set of TRPs authorized to receive the PRU label assistance report, and/or (f) an indication of a NW vendor associated with a second set of TRPs authorized to receive the PRU label assistance report. The set of PRUs 604 may transmit the indication 616 of the permission to share a PRU label assistance report using a TRP information indication of NRPPa protocol. In some aspects, the set of PRUs 604 may transmit a TRP information indication message including the indication 616 of the permission to share a PRU label assistance report. In some aspects, the set of PRUs 604 may transmit an NRPPa message including the indication 616 of the permission to share a PRU label assistance report. The network entity 606 may share the PRU label assistance report with one or more wireless entities based on the indication 616 of the permission to share a PRU label assistance report. For example, the network entity 606 may share the PRU label assistance report with a set of UEs that have UE IDs that match the a set of UE IDs indicated by the indication 616 of the permission to share a PRU label assistance report.

The set of UEs/PRUs 602 may transmit the set of SRSs 618 to the set of PRUs 604. The set of PRUs 604 may receive the set of SRSs 618 from the set of UEs/PRUs 602. At 624, the set of PRUs 604 may measure the set of SRSs 618 for positioning. The set of PRUs 604 may transmit a set of PRU label assistance reports 626 to the network entity 606. The network entity 606 may receive the set of PRU label assistance reports 626 from the set of PRUs 604. The set of PRU label assistance reports 626 may include PRU positioning measurements based on the measurements taken at 624 of the set of SRSs 618. The set of PRU label assistance reports 626 may include PRU assistance information associated with the set of PRUs 604, associated with the set of SRSs 618 received by the set of PRUs 604, associated with measurements taken at 624 of the set of SRSs 618, and/or associated with the set of PRSs 620 transmitted by the set of PRUs 604 and received by the set of UEs/PRUs 602 (e.g., location of a transmitting PRU, PRS beam angle information, TX group delay information). The set of PRUs 604 may transmit the set of PRU label assistance reports 626 as part of NRPPa TRP information exchange and measurement exchange. In other words, the set of PRUs 604 may transmit a TRP information exchange and measurement exchange message that includes at least one of the set of PRU label assistance reports 626.

The set of PRUs 604 may transmit the set of PRSs 620 to the set of UEs/PRUs 602. The set of UEs/PRUs 602 may receive the set of PRSs 620 from the set of PRUs 604. At 622, the set of UEs/PRUs 602 may measure the set of PRSs 620 for positioning. PRUs of the set of UEs/PRUs 602 may transmit a set of PRU label assistance reports as the set of PRU label assistance/measurement reports 628 to the network entity 606. The network entity 606 may receive the set of PRU label assistance reports as the set of PRU label assistance/measurement reports 628 from PRUs of the set of UEs/PRUs 602. The set of PRU label assistance reports of the set of PRU label assistance/measurement reports 628 may include PRU positioning measurements based on the measurements taken at 622 of the set of PRSs 620. The set of PRU label assistance reports of the set of PRU label assistance/measurement reports 628 may include PRU assistance information associated with PRUs of the set of UEs/PRUs 602, associated with the set of PRSs 620 received by PRUs of the set of PRUs 602, associated with measurements taken at 622 of the set of PRSs 620, and/or with the set of SRSs 618 transmitted by the set of UEs/PRUs 602 and received by the set of PRUS 604 (e.g., a location of a transmitting PRU, SRS beam angle information, TX group delay information). UEs of the set of UEs/PRUs 602 may transmit a set of measurement reports as the set of PRU label assistance/measurement reports 628 to the network entity 606. The network entity 606 may receive the set of measurement reports as the set of PRU label assistance/measurement reports 628 from UEs of the set of UEs/PRUs 602. The set of measurement reports of the set of PRU label assistance/measurement reports 628 may include PRU positioning measurements based on the measurements taken at 622 of the set of PRSs 620.

The network entity 606 may transmit the set of PRU label assistance reports 630 based on the set of PRU label assistance reports 626 and/or the PRU label assistance reports of the set of PRU label assistance/measurement reports 628. The set of PRU label assistance reports 630 may include at least a portion of the set of PRU label assistance reports 626 and/or the PRU label assistance reports of the set of PRU label assistance/measurement reports 628. The network entity 606 may transmit the set of PRU label assistance reports 630 to the set of UEs/PRUs 602, for example a UE that transmitted the request 608 for positioning to the network entity 606. The set of UEs/PRUs 602 may receive the set of PRU label assistance reports 630 from the network entity 606. The network entity 606 may transmit an assistance exchange message including the set of PRU label assistance reports 630. The network entity 606 may transmit an LPPa message including the set of PRU label assistance reports 630. In other words, the network entity 606 may share the set of PRU label assistance reports 630 with the set of UEs/PRUs 602 using the assistance exchange of LPPa protocol.

At 632, the set of UEs/PRUs 602 may process the set of PRU label assistance reports 630. In one aspect, the set of UEs/PRUs 602 may train a positioning model based on data and labels of the set of PRU label assistance reports 630. In another aspect, the set of UEs/PRUs 602 may calculate a position of a wireless device based on the set of PRU label assistance reports 630 by utilizing a trained positioning model.

At 634, the network entity 606 may process the set of PRU label assistance reports 626 and/or PRU label assistance reports of the PRU label assistance/measurement reports 628. In one aspect, the network entity 606 may train a positioning model based on data and labels of the set of PRU label assistance reports 626 and/or PRU label assistance reports of the PRU label assistance/measurement reports 628. In another aspect, the network entity 606 may calculate a position of a wireless device based on the set of PRU label assistance reports 626 and/or PRU label assistance reports of the PRU label assistance/measurement reports 628 by utilizing a trained positioning model.

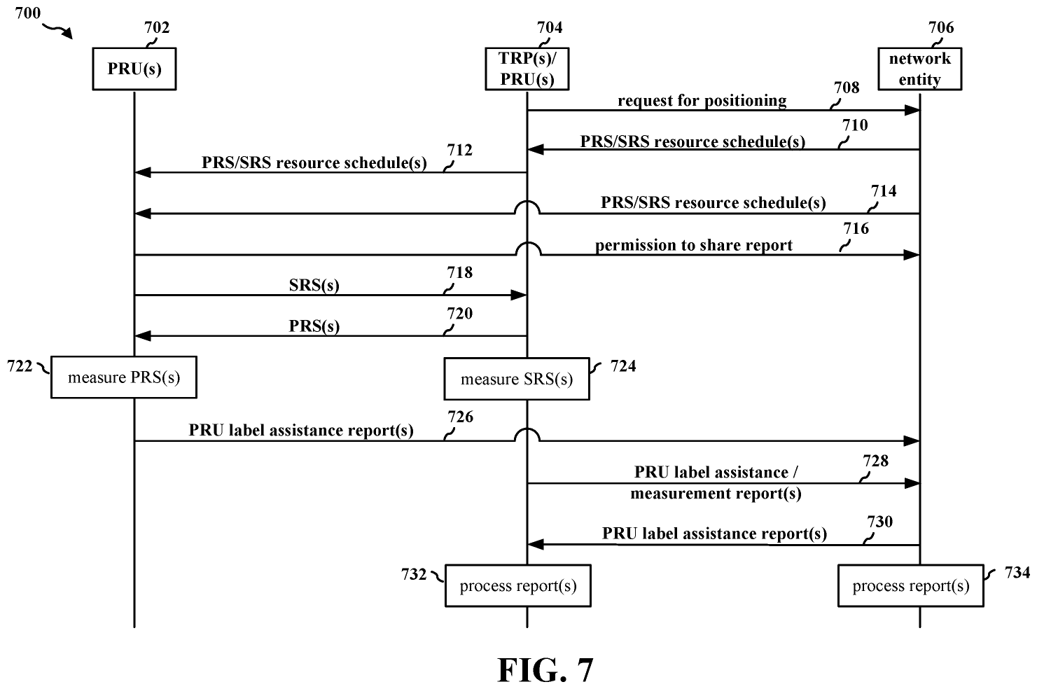

FIG. 7 is a connection flow diagram 700 illustrating an example of a set of PRUs 702 and a set of TRPs/PRUs 704 configured to perform positioning with one another. The set of TRPs/PRUs 704 may include at least one TRP, may include at least one PRU, or may include at least one TRP and at least one PRU. A TRP of the set of TRPs/PRUs 704 may not be configured to share a PRU label assistance report with other wireless devices, but may be configured to share measurement reports of measured positioning signals, such as measured SRSs. In some aspects, a PRU may be realized by a UE with a known location. In some aspects, a PRU may be realized by a mobile TRP with a known location. In some aspects, the set of TRPs/PRUs 704 may include a PRU configured to emulate a TRP during positioning. The network entity 706 may include an LMF. The network entity 706 may include a positioning server. In some aspects, the set of TRPs/PRUs 704 may include the network entity 706, such that one of the set of TRPs/PRUs 704 may coordinate positioning between the set of PRUs 702 and the set of TRPs/PRUs 704.

The set of TRPs/PRUs 704 and/or the network entity 706 may know the location of any of the PRUs of the set of TRPs/PRUs 704 or the set of PRUs 702. For example, the network entity 706 may have a database of known locations of each of the set of PRUs 702. In some aspects, a PRU may calculate its location using positioning, or using other sensors/non-RF positioning methods (e.g., a GNSS fix using a high-accuracy GNSS or by traveling to a known location at a prearranged time) and may transmit its location to the network entity 706, which may update other wireless devices, such as the set of TRPs/PRUs 704, of the location of the PRU. In other aspects, a PRU of the set of PRUs 702 may broadcast its calculated location to other wireless devices, such as the set of TRPs/PRUs 704. In other aspects, the network entity 706 may perform positioning on a PRU of the set of PRUs 702, and may then update other wireless devices, such as the set of TRPs/PRUs 704, of the location of the PRU.

At least one of the set of TRPs/PRUs 704 may transmit a request 708 for positioning to the network entity 706. The network entity 706 may receive the request 708 for positioning. The request 708 may be transmitted as a part of TRP information exchange of NRPPa protocol between the set of TRPs/PRUs 704 and the network entity 706. In one aspect, the set of TRPs/PRUs 704 may transmit an NRPPa message to the network entity 706 including the request 708 for positioning. In one aspect, the set of TRPs/PRUs 704 may transmit a TRP information exchange and measurement exchange message to the network entity 706 including the request 708 for positioning. The request 708 for positioning may request the network entity 706 to configure positioning between the set of PRUs 702 and the set of TRPs/PRUs 704, for example to configure the set of SRSs 718 and/or to configure the set of PRSs 720.

The request 708 for positioning may include a request for a PRU to transmit a PRU label assistance report that may be shared with at least one of the set of TRPs/PRUs 704. The request 708 for positioning may include an indication of information that may be included in the PRU label assistance report. The request 708 for positioning may include a request for PRU positioning measurements, for example a request for measurements of the set of SRSs by the set of TRPs/PRUs 704, and/or a request for measurements of the set of PRSs by the set of PRUs 702. The request 708 for positioning may include a request for the network entity 706 to configure resources for positioning. In one aspect, the request 708 for positioning may include a request for the network entity 706 to configure SRS resources for the set of PRUs 702 to transmit the set of SRSs 718 to the set of TRPs/PRUs 704 and for the set of TRPs/PRUs 704 to receive the set of SRSs 718. In one aspect, the request 708 for positioning may include a request for the network entity 706 to configure PRS resources for the set of TRPs/PRUs 704 to transmit the set of PRSs 720 to the set of PRUs 702 and for the set of PRUs 702 to receive the set of PRSs 720.

The request 708 for positioning may include a request for PRU assistance information. The PRU assistance information may include an indication of a location of at least one of the set of PRUs 702. The PRU assistance information may include an indication of a location of at least one of the PRUs of the set of TRPs/PRUs 704. The PRU assistance information may include an indication of a beam angle associated with a set of positioning signals received or transmitted by the set of PRUs 702. In one aspect, the PRU assistance information may include a calculated AoA of the set of PRSs 720. In another aspect, the PRU assistance information may include a calculated AoD of the set of SRSs 718. The PRU assistance information may include an indication of a beam angle associated with a set of positioning signals received or transmitted by PRUs of the set of TRPs/PRUs 704. In one aspect, the PRU assistance information may include a calculated AoA of the set of SRSs 718 received by PRUs of the set of TRPs/PRUs 704. In another aspect, the PRU assistance information may include a calculated AoD of the set of PRSs 720 transmitted by PRUs of the set of TRPs/PRUs 704. The PRU assistance information may include an indication of an antenna orientation associated with the set of PRUs 702 transmitting or receiving a set of positioning signals. In one aspect, the PRU assistance information may include a set of orientations of a set of antennas of the set of PRUs 702 that receive the set of PRSs 720. In another aspect, the PRU assistance information may include a set of orientations of a set of antennas of the set of PRUs 702 that transmit the set of SRSs 718. The PRU assistance information may include an indication of an antenna orientation associated with PRUs of the set of TRPs/PRUs 704 transmitting or receiving a set of positioning signals. In one aspect, the PRU assistance information may include a set of orientations of a set of antennas of PRUs of the set of TRPs/PRUs 704 that receive the set of SRSs 718. In another aspect, the PRU assistance information may include a set of orientations of a set of antennas of PRUs of the set of TRPs/PRUs 704 that transmit the set of PRSs 720. The PRU assistance information may include an indication of a group delay associated with the set of PRUs 702 measuring the set of PRSs 720. The PRU assistance information may include an indication of a group delay associated with PRUs of the set of TRPs/PRUs 704 measuring the set of SRSs 718. The PRU assistance information may include an indication of a sensor measurement associated with the set of PRUs 702 measuring the set of PRSs 720. The PRU assistance information may include an indication of a sensor measurement associated with PRUs of the set of TRPs/PRUs 704 measuring the set of SRSs 718. The PRU assistance information may include an indication of a sensor type associated with at least one PRU of the set of PRUs 702. The PRU assistance information may include an indication of a sensor type associated with a PRU of the set of TRPs/PRUs 704. The PRU assistance information may include an indication of a synchronization error associated with the set of PRUs 702 measuring the set of PRSs 720. The PRU assistance information may include an indication of a synchronization error associated with PRUs of the set of TRPs/PRUs 704 measuring the set of SRSs 718. The PRU assistance information may include an indication of a Tx-Rx or Rx-Tx timing error associated with the set of PRUs 702 measuring the set of PRSs 720. The PRU assistance information may include an indication of a Tx-Rx or Rx-Tx timing error associated with PRUs of the set of TRPs/PRUs 704 measuring the set of SRSs 718. The PRU assistance information may include an indication of a clock drift range associated with the set of PRUs 702 measuring the set of PRSs 720. The PRU assistance information may include an indication of a clock drift range associated with PRUs of the set of TRPs/PRUs 704 measuring the set of SRSs 718.

In response to receiving the request 708 for positioning, the network entity 706 may transmit a set of PRS/SRS resource schedules 710 to the set of TRPs/PRUs 704. The set of TRPs/PRUs 704 may receive the set of PRS/SRS resource schedules 710. The set of PRS/SRS resource schedules 710 may configure the set of TRPs/PRUs 704 to receive the set of SRSs 718. The set of PRS/SRS resource schedules 710 may configure the set of TRPs/PRUs 704 to transmit the set of PRSs 720. The network entity 706 may transmit the set of PRS/SRS resource schedules 710 via an NRPPa message. The network entity 706 may transmit the set of PRS/SRS resource schedules 710 as part of an NRPPa TRP information exchange and measurement exchange.

In some aspects, at least some of the set of TRPs/PRUs 704 may configure a set of PRS/SRS resource schedules 712 based on the set of PRS/SRS resource schedules 710. For example, some of the set of TRPs/PRUs 704 may be serving cells of the set of PRUs 702. The set of TRPs/PRUs 704 may transmit the set of PRS/SRS resource schedules 712 to the set of PRUs 702. The set of PRUs 702 may receive the set of PRS/SRS resource schedules 712 from the set of TRPs/PRUs 704. The set of PRS/SRS resource schedules 712 may configure the set of PRUs 702 to transmit the set of SRSs 718 to the set of TRPs/PRUs 704. The set of PRS/SRS resource schedules 712 may configure the set of PRUs 702 to receive the set of PRSs 720 from the set of TRPs/PRUs 704. The set of TRPs/PRUs 704 may transmit the set of PRS/SRS resource schedules 712 as an RRC configuration.

In other aspects, the network entity 706 may directly configure the set of PRS/SRS resource schedules 714 for the set of PRUs 702. The network entity 706 may transmit the set of PRS/SRS resource schedules 714 to the set of PRUs 702. The set of PRUs 702 may receive the set of PRS/SRS resource schedules 714 from the network entity 706. The set of PRS/SRS resource schedules 714 may configure the set of PRUs 702 to transmit the set of SRSs 718 to the set of TRPs/PRUs 704. The set of PRS/SRS resource schedules 714 may configure the set of PRUs 702 to receive the set of PRSs 720 from the set of TRPs/PRUs 704. The network entity 706 may transmit the set of PRS/SRS resource schedules 714 as an RRC configuration. The set of PRS/SRS resource schedules 714 may request the set of PRUs 702 to share a PRU label assistance report with the network entity 706. Such a request may indicate what types of PRU positioning measurements and/or PRU assistance information may be included in the PRU label assistance report. The set of PRS/SRS resource schedules 714 may request the set of PRUs 702 to share a permissibility/consent rule with the network entity 706.

In response to receiving, from the network entity 706, a request to share a PRU label assistance report with the network entity 706, the set of PRUs 702 may transmit an indication 716 of a permission to share a PRU label assistance report to the network entity 706. The network entity 706 may receive the indication 716 of the permission to share a PRU label assistance report. The indication 716 of the permission to share a PRU label assistance report may include a permissibility/consent rule to share a PRU label assistance report, PRU assistance information, and/or PRU positioning measurements with a set of wireless devices. The permissibility/consent rule may indicate a set of wireless devices that a PRU label assistance report may be shared with. In some aspects, the permissibility/consent rule may be open without specifying the UEs, network nodes, and/or PRUs that may obtain PRU positioning measurements, PRU assistance information, or a PRU label assistance report. In some aspects, the permissibility/consent rule may specify the UEs, network nodes, and/or PRUs that may obtain PRU positioning measurements, PRU assistance information, or a PRU label assistance report. In some aspects, the permissibility/consent rule may categorize a set of UEs and/or a set of PRUs based on their UE ID, UE vendor, and/or their UE chip vendor. For example, the permissibility/consent rule may include a list of UE identifiers (IDs). In some aspects, the permissibility/consent rule may categorize a set of network nodes and/or a set of PRUs based on their cell ID, TRP ID, network vendor and/or their network operator. In other words, the indication 716 of the permission to share the PRU label assistance report may include at least one of (a) a set of UE IDs associated with a set of UEs authorized to receive the PRU label assistance report, (b) an indication of a UE vendor associated with a first set of UEs authorized to receive the PRU label assistance report, (c) an indication of a UE chip vendor associated with a second set of UEs authorized to receive the PRU label assistance report, (d) a set of TRP IDs associated with TRPs authorized to receive the PRU label assistance report, (e) an indication of a NW operator associated with a first set of TRPs authorized to receive the PRU label assistance report, and/or (f) an indication of a NW vendor associated with a second set of TRPs authorized to receive the PRU label assistance report. The set of PRUs 702 may transmit the indication 716 of the permission to share a PRU label assistance report using a UE capability message indication of LPPa protocol. In some aspects, the set of PRUs 702 may transmit a capability message including the indication 716 of the permission to share a PRU label assistance report. In some aspects, the set of PRUs 702 may transmit an LPPa message including the indication 716 of the permission to share a PRU label assistance report. The network entity 706 may share the PRU label assistance report with one or more wireless entities based on the indication 716 of the permission to share a PRU label assistance report. For example, the network entity 706 may share the PRU label assistance report with a set of UEs that have UE IDs that match the a set of UE IDs indicated by the indication 716 of the permission to share a PRU label assistance report.

The set of TRPs/PRUs 704 may transmit the set of PRSs 720 to the set of PRUs 702. The set of PRUs 702 may receive the set of PRSs 720 from the set of TRPs/PRUs 704. At 722, the set of PRUs 702 may measure the set of PRSs 720 for positioning. The set of PRUs 702 may transmit a set of PRU label assistance reports 726 to the network entity 706. The network entity 706 may receive the set of PRU label assistance reports 726 from the set of PRUs 702. The set of PRU label assistance reports 726 may include PRU positioning measurements based on the measurements taken at 722 of the set of PRSs 720. The set of PRU label assistance reports 726 may include PRU assistance information associated with the set of PRUs 702, associated with the set of PRSs 720 received by the set of PRUs 702, associated with measurements taken at 722 of the set of PRSs 720, and/or associated with the set of SRSs 718 transmitted by the set of PRUs 702 and received by the set of TRPs/PRUs 704 (e.g., location of a transmitting PRU, SRS beam angle information, TX group delay information). The set of PRUs 702 may transmit the set of PRU label assistance reports 726 as part of assistance data exchange of LPPa protocol. In other words, the set of PRUs 702 may transmit an assistance data exchange message that includes at least one of the set of PRU label assistance reports 726.

The set of PRUs 702 may transmit the set of SRSs 718 to the set of TRPs/PRUs 704. The set of TRPs/PRUs 704 may receive the set of SRSs 718 from the set of PRUs 702. At 724, the set of TRPs/PRUs 704 may measure the set of SRSs 718 for positioning. PRUs of the set of TRPs/PRUs 704 may transmit a set of PRU label assistance reports as the set of PRU label assistance/measurement reports 728 to the network entity 706. The network entity 706 may receive the set of PRU label assistance reports as the set of PRU label assistance/measurement reports 728 from PRUs of the set of TRPs/PRUs 704. The set of PRU label assistance reports of the set of PRU label assistance/measurement reports 728 may include PRU positioning measurements based on the measurements taken at 724 of the set of SRSs 718. The set of PRU label assistance reports of the set of PRU label assistance/measurement reports 728 may include PRU assistance information associated with PRUs of the set of TRPs/PRUs 704, associated with the set of SRSs 718 received by PRUs of the set of TRPs/PRUs 704, associated with measurements taken at 724 of the set of SRSs 718, and/or associated with the set of PRSs transmitted by the set of TRPs/PRUs 704 and received by the set of PRUs 702 (e.g., location of a transmitting PRU, PRS beam angle information, TX group delay information). TRPs of the set of TRPs/PRUs 704 may transmit a set of measurement reports as the set of PRU label assistance/measurement reports 728 to the network entity 706. The network entity 706 may receive the set of measurement reports as the set of PRU label assistance/measurement reports 728 from UEs of the set of PRUs 702. The set of measurement reports of the set of PRU label assistance/measurement reports 728 may include PRU positioning measurements based on the measurements taken at 724 of the set of SRSs 718.

The network entity 706 may transmit the set of PRU label assistance reports 730 based on the set of PRU label assistance reports 726 and/or the PRU label assistance reports of the set of PRU label assistance/measurement reports 728. The set of PRU label assistance reports 730 may include at least a portion of the set of PRU label assistance reports 726 and/or the PRU label assistance reports of the set of PRU label assistance/measurement reports 728. The network entity 706 may transmit the set of PRU label assistance reports 730 to the set of TRPs/PRUs 704, for example a TRP that transmitted the request 708 for positioning. The set of TRPs/PRUs 704 may receive the set of PRU label assistance reports 730 from the network entity 706. The network entity 706 may transmit a TRP information exchange and measurement exchange message including the set of PRU label assistance reports 730. The network entity 706 may transmit an NRPPa message including the set of PRU label assistance reports 730. In other words, the network entity 706 may share the set of PRU label assistance reports 730 with the set of TRPs/PRUs 704 using the TRP information exchange and measurement exchange of NRPPa protocol.

At 732, the set of TRPs/PRUs 704 may process the set of PRU label assistance reports 730. In one aspect, the set of TRPs/PRUs 704 may train a positioning model based on data and labels of the set of PRU label assistance reports 730. In another aspect, the set of TRPs/PRUs 704 may calculate a position of a wireless device based on the set of PRU label assistance reports 730 by utilizing a trained positioning model.

At 734, the network entity 706 may process the set of PRU label assistance reports 726 and/or PRU label assistance reports of the PRU label assistance/measurement reports 728. In one aspect, the network entity 706 may train a positioning model based on data and labels of the set of PRU label assistance reports 726 and/or PRU label assistance reports of the PRU label assistance/measurement reports 728. In another aspect, the network entity 706 may calculate a position of a wireless device based on the set of PRU label assistance reports 726 and/or PRU label assistance reports of the PRU label assistance/measurement reports 728 by utilizing a trained positioning model.

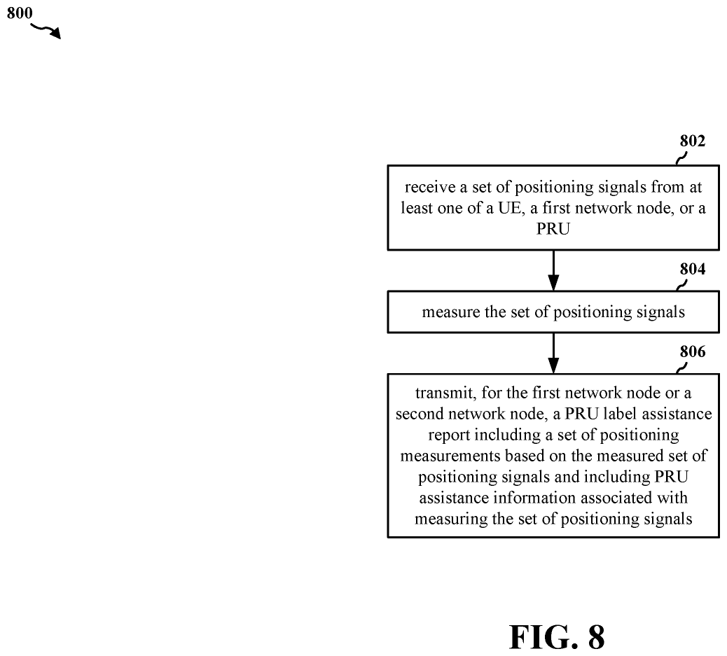

FIG. 8 is a flowchart 800 of a method of wireless communication. The method may be performed by a wireless device (e.g., the UE 104, the UE 350; the wireless device 402, the wireless device 404, the wireless device 406; the UE/PRU 502; the set of UEs/PRUs 602; the PRU 504; the set of PRUs 604, the set of PRUs 702, the base station 102, the base station 310; the TRP/PRU 506, the set of TRPs/PRUs 704; the network entity 606, the network entity 706; the apparatus 1704; the network entity 1702, the network entity 1802, the network entity 1960). At 802, the wireless device may receive a set of positioning signals from at least one of a UE, a first network node, or a PRU. For example, 802 may be performed by the set of PRUs 604 in FIG. 6, which may receive the set of SRSs 618 from the set of UEs/PRUs 602. In another example, 802 may be performed by the set of PRUs 702 in FIG. 7, which may receive the set of PRSs 720 from the set of TRPs/PRUs 704. Moreover, 802 may be performed by the component 198 in FIG. 1, 3, 17, 18, or 19.

At 804, the wireless device may measure the set of positioning signals. For example, 804 may be performed by the set of PRUs 604 in FIG. 6, which may, at 624, measure the set of SRSs 618. In another example, 804 may be performed by the set of PRUS 702 in FIG. 7, which may, at 722, measure the set of PRSs 720. Moreover, 804 may be performed by the component 198 in FIG. 1, 3, 17, 18, or 19.

At 806, the wireless device may transmit, for the first network node or a second network node, a PRU label assistance report. The PRU label assistance report may include a set of positioning measurements based on the measured set of positioning signals. The PRU label assistance report may include PRU assistance information associated with measuring the set of positioning signals. For example, 806 may be performed by the set of PRUs 604 in FIG. 6, which may transmit, for the network entity 606, the set of PRU label assistance reports 626. The set of PRU label assistance reports 626 may include the set of positioning measurements made at 624 based on the set of SRSs 618. The set of PRU label assistance reports 626 may include PRU assistance information associated with measuring the set of SRSs 618. In another example, 806 may be performed by the set of PRUs 702 in FIG. 7, which may transmit, for the network entity 706, the set of PRU label assistance reports 726. The set of PRU label assistance reports 726 may include the set of positioning measurements made at 722 based on the set of PRSs 720. The set of PRU label assistance reports 726 may include PRU assistance information associated with measuring the set of PRSs 720. Moreover, 806 may be performed by the component 198 in FIG. 1, 3, 17, 18, or 19.

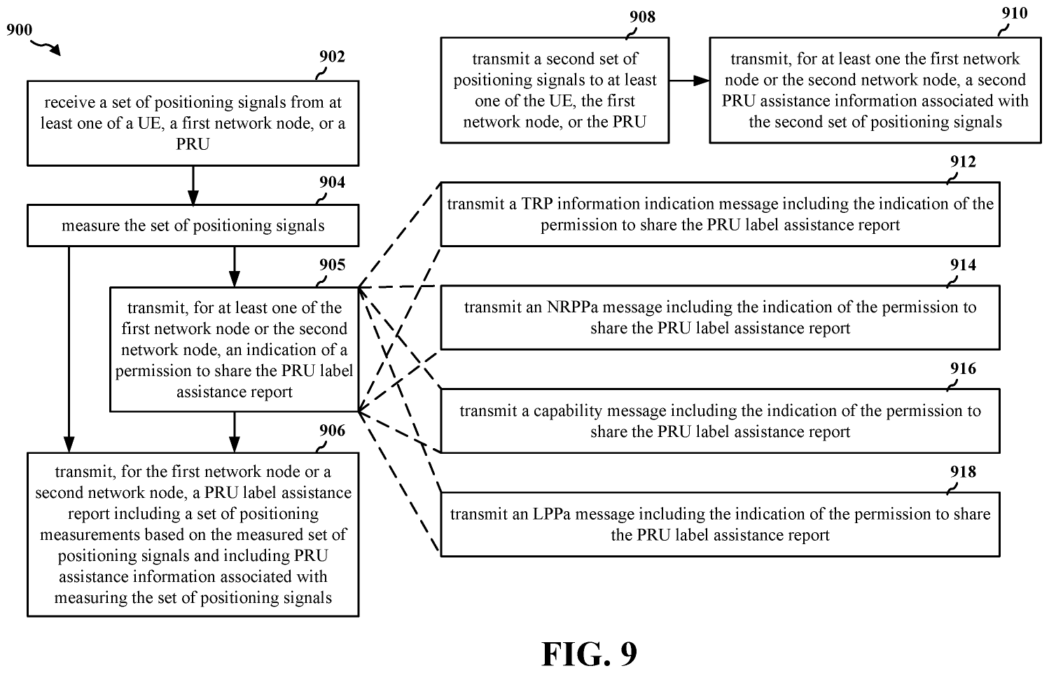

FIG. 9 is a flowchart 900 of a method of wireless communication. The method may be performed by a wireless device (e.g., the UE 104, the UE 350; the wireless device 402, the wireless device 404, the wireless device 406; the UE/PRU 502; the set of UEs/PRUs 602; the PRU 504; the set of PRUs 604, the set of PRUs 702, the base station 102, the base station 310; the TRP/PRU 506, the set of TRPs/PRUs 704; the network entity 606, the network entity 706; the apparatus 1704; the network entity 1702, the network entity 1802, the network entity 1960). At 902, the wireless device may receive a set of positioning signals from at least one of a UE, a first network node, or a PRU. For example, 902 may be performed by the set of PRUs 604 in FIG. 6, which may receive the set of SRSs 618 from the set of UEs/PRUs 602. In another example, 902 may be performed by the set of PRUs 702 in FIG. 7, which may receive the set of PRSs 720 from the set of TRPs/PRUs 704. Moreover, 902 may be performed by the component 198 in FIG. 1, 3, 17, 18, or 19.

At 904, the wireless device may measure the set of positioning signals. For example, 904 may be performed by the set of PRUs 604 in FIG. 6, which may, at 624, measure the set of SRSs 618. In another example, 904 may be performed by the set of PRUs 702 in FIG. 7, which may, at 722, measure the set of PRSs 720. Moreover, 904 may be performed by the component 198 in FIG. 1, 3, 17, 18, or 19.

At 905, the wireless device may transmit, for at least one of the first network node or the second network node, an indication of a permission to share the PRU label assistance report. For example, 905 may be performed by the set of PRUs 604 in FIG. 6, which may transmit the indication 616 of a permission to share a PRU label assistance report to the network entity 606 or another network node, such as an LMF or a core network. In another example, 905 may be performed by the set of PRUs 702 in FIG. 7, which may transmit the indication 716 of a permission to share a PRU label assistance report to the network entity 706 or another network node, such as an LMF or a core network. Moreover, 905 may be performed by the component 198 in FIG. 1, 3, 17, 18, or 19.

At 906, the wireless device may transmit, for the first network node or a second network node, a PRU label assistance report. The PRU label assistance report may include a set of positioning measurements based on the measured set of positioning signals. The PRU label assistance report may include PRU assistance information associated with measuring the set of positioning signals. For example, 906 may be performed by the set of PRUs 604 in FIG. 6, which may transmit, for the network entity 606, the set of PRU label assistance reports 626. The set of PRU label assistance reports 626 may include the set of positioning measurements made at 624 based on the set of SRSs 618. The set of PRU label assistance reports 626 may include PRU assistance information associated with measuring the set of SRSs 618. In another example, 906 may be performed by the set of PRUs 702 in FIG. 7, which may transmit, for the network entity 706, the Set of PRU label assistance reports 726. The Set of PRU label assistance reports 726 may include the set of positioning measurements made at 722 based on the set of PRSs 720. The Set of PRU label assistance reports 726 may include PRU assistance information associated with measuring the set of PRSs 720. Moreover, 906 may be performed by the component 198 in FIG. 1, 3, 17, 18, or 19.

At 908, the wireless device may transmit a second set of positioning signals to at least one of the UE, the first network node, or the PRU. For example, 908 may be performed by the set of PRUs 604 in FIG. 6, which may transmit the set of PRSs 620 to the set of UEs/PRUs 602. The set of PRSs 620 may also be received by the network entity 606. In another example, 908 may be performed by the set of PRUs 702 in FIG. 7, which may transmit the set of SRSs 718 to the set of TRPs/PRUs 704. The set of SRSs 718 may also be received by the network entity 706. Moreover, 908 may be performed by the component 198 in FIG. 1, 3, 17, 18, or 19.

At 910, the wireless device may transmit, for at least one the first network node or the second network node, a second PRU assistance information associated with the second set of positioning signals. The second PRU assistance information may include TX configurations, such as beam angle information used for the second set of positioning signals. For example, 910 may be performed by the set of PRUs 604 in FIG. 6, which may transmit the set of PRU label assistance reports 626 to the network entity 606 or another network node, such as an LMF or a core network, which may include a second PRU assistance information associated with the set of PRSs 620. In another example, 910 may be performed by the set of PRUs 702 in FIG. 7, which may transmit the set of PRU label assistance reports 726 to the network entity 706 or another network node, such as an LMF or a core network, that may include a second PRU assistance information associated with the set of SRSs 718. Moreover, 910 may be performed by the component 198 in FIG. 1, 3, 17, 18, or 19.

In some aspects, the wireless device may receive, from at least one of the first network node or the second network node, a request to transmit the PRU label assistance report. In response to receiving the request, the wireless device may transmit, for the first network node or a second network node, a PRU label assistance report including the second PRU assistance information associated with the second set of positioning signals. For example, this may be performed by the set of PRUs 604 in FIG. 6, which may receive a request from the network entity 606 or another network node, such as an LMF or a core network, for the set of PRU label assistance reports 626. The set of PRUs 604 may transmit the set of PRU label assistance reports 626 to the network entity 606 or another network node, such as an LMF or a core network, in response to the request. In another example, this may be performed by the set of PRUs 702 in FIG. 7, which may receive a request from the network entity 706 or another network node, such as an LMF or a core network, for the set of PRU label assistance reports 726. The set of PRUs 702 may transmit the set of PRU label assistance reports 726 to the network entity 706 or another network node, such as an LMF or a core network, in response to the request.

At 912, the wireless device may transmit a TRP information indication message including the indication of the permission to share the PRU label assistance report. For example, 912 may be performed by the set of PRUs 604 in FIG. 6, which may transmit the indication 616 of a permission to share a PRU label assistance report as a TRP information indication message to the network entity 606. Moreover, 912 may be performed by the component 198 in FIG. 1, 3, 17, 18, or 19.

At 914, the wireless device may transmit an NRPPa message including the indication of the permission to share the PRU label assistance report. For example, 914 may be performed by the set of PRUs 604 in FIG. 6, which may transmit the indication 616 of a permission to share a PRU label assistance report as an NRPPa message to the network entity 606. Moreover, 914 may be performed by the component 198 in FIG. 1, 3, 17, 18, or 19.

At 916, the wireless device may transmit a capability message including the indication of the permission to share the PRU label assistance report. For example, 916 may be performed by the set of PRUs 604 in FIG. 6, which may transmit the indication 616 of a permission to share a PRU label assistance report as a capability message to the network entity 606. In another example, 916 may be performed by the set of PRUS 702 in FIG. 7, which may transmit the indication 716 of a permission to share a PRU label assistance report as a capability message to the network entity 706. Moreover, 916 may be performed by the component 198 in FIG. 1, 3, 17, 18, or 19.

At 918, the wireless device may transmit an LPPa message including the indication of the permission to share the PRU label assistance report. For example, 918 may be performed by the set of PRUs 702 in FIG. 7, which may transmit the indication 716 of a permission to share a PRU label assistance report as an LPPa message to the network entity 706. Moreover, 918 may be performed by the component 198 in FIG. 1, 3, 17, 18, or 19.

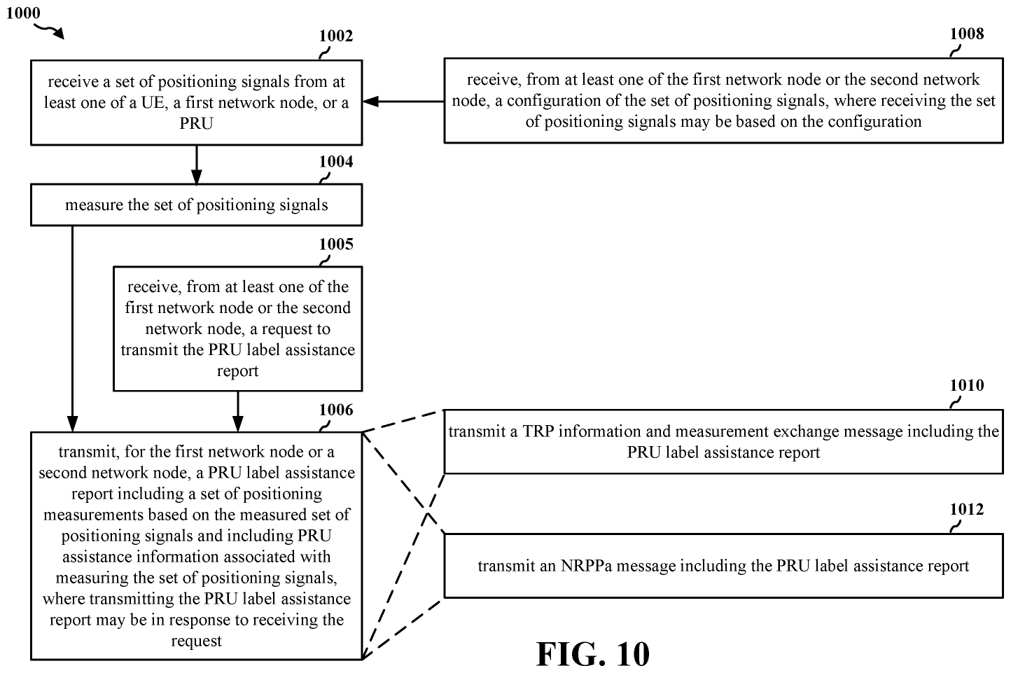

FIG. 10 is a flowchart 1000 of a method of wireless communication. The method may be performed by a wireless device (e.g., the UE 104, the UE 350; the wireless device 402, the wireless device 404, the wireless device 406; the UE/PRU 502; the set of UEs/PRUs 602; the PRU 504; the set of PRUs 604, the set of PRUs 702, the base station 102, the base station 310; the TRP/PRU 506, the set of TRPs/PRUs 704; the network entity 606, the network entity 706; the apparatus 1704; the network entity 1702, the network entity 1802, the network entity 1960). At 1002, the wireless device may receive a set of positioning signals from at least one of a UE, a first network node, or a PRU. For example, 1002 may be performed by the set of PRUs 604 in FIG. 6, which may receive the set of SRSs 618 from the set of UEs/PRUs 602. In another example, 1002 may be performed by the set of PRUs 702 in FIG. 7, which may receive the set of PRSs 720 from the set of TRPs/PRUs 704. Moreover, 1002 may be performed by the component 198 in FIG. 1, 3, 17, 18, or 19.

At 1004, the wireless device may measure the set of positioning signals. For example, 1004 may be performed by the set of PRUs 604 in FIG. 6, which may, at 624, measure the set of SRSs 618. In another example, 1004 may be performed by the set of PRUs 702 in FIG. 7, which may, at 722, measure the set of PRSs 720. Moreover, 1004 may be performed by the component 198 in FIG. 1, 3, 17, 18, or 19.

At 1005, the wireless device may receive, from at least one of the first network node or the second network node, a request to transmit the PRU label assistance report. For example, 1005 may be performed by the set of PRUs 604 in FIG. 6, which may receive, from the network entity 606 or a second network node, such as an LMF or a core network, a request to transmit the set of PRU label assistance reports 626. In another example, 1005 may be performed by the set of PRUs 702 in FIG. 7, which may receive, from the network entity 706 or a second network node, such as an LMF or a core network, a request to transmit the set of PRU label assistance reports 726. Moreover, 1005 may be performed by the component 198 in FIG. 1, 3, 17, 18, or 19.

At 1006, the wireless device may transmit, for the first network node or a second network node, a PRU label assistance report. The PRU label assistance report may include a set of positioning measurements based on the measured set of positioning signals. The PRU label assistance report may include PRU assistance information associated with measuring the set of positioning signals. For example, 1006 may be performed by the set of PRUs 604 in FIG. 6, which may transmit, for the network entity 606, the set of PRU label assistance reports 626. The set of PRU label assistance reports 626 may include the set of positioning measurements made at 624 based on the set of SRSs 618. The set of PRU label assistance reports 626 may include PRU assistance information associated with measuring the set of SRSs 618. In another example, 1006 may be performed by the set of PRUs 702 in FIG. 7, which may transmit, for the network entity 706, the Set of PRU label assistance reports 726. The Set of PRU label assistance reports 726 may include the set of positioning measurements made at 722 based on the set of PRSs 720. The Set of PRU label assistance reports 726 may include PRU assistance information associated with measuring the set of PRSs 720. Moreover, 1006 may be performed by the component 198 in FIG. 1, 3, 17, 18, or 19.

At 1008, the wireless device may receive, from at least one of the first network node or the second network node, a configuration of the set of positioning signals. Receiving the set of positioning signals may be based on the configuration. For example, 1008 may be performed by the set of PRUs 604 in FIG. 6, which may receive the set of PRS/SRS resource schedules 610 from the network entity 606, or another network node, such as an LMF or a core network. The set of PRS/SRS resource schedules 610 may configure the set of SRSs 618 and/or the set of PRSs 620. Receiving the set of SRSs 618 may be based on the set of PRS/SRS resource schedules 610. In another example, 1008 may be performed by the set of PRUs 702 in FIG. 7, which may receive the set of PRS/SRS resource schedules 714 from the network entity 706 or the set of PRS/SRS resource schedules 712 from at least one of the set of TRPs/PRUs 704. The set of PRS/SRS resource schedules 712 or set of PRS/SRS resource schedules 714 may configure the set of SRSs 718 and/or the set of PRSs 720. Receiving the set of PRSs 720 may be based on at least one of the set of PRS/SRS resource schedules 712 or set of PRS/SRS resource schedules 714. Moreover, 1008 may be performed by the component 198 in FIG. 1, 3, 17, 18, or 19.

At 1010, the wireless device may transmit a TRP information and measurement exchange message including the PRU label assistance report. For example, 1010 may be performed by the set of PRUs 604 in FIG. 6, which may transmit the set of PRU label assistance reports 626 as a TRP information and measurement exchange message that includes the set of reports. Moreover, 1010 may be performed by the component 198 in FIG. 1, 3, 17, 18, or 19.

At 1012, the wireless device may transmit an NRPPa message including the PRU label assistance report. For example, 1012 may be performed by the set of PRUs 604 in FIG. 6, which may transmit the set of PRU label assistance reports 626 as an NRPPa message that includes the set of reports. Moreover, 1012 may be performed by the component 198 in FIG. 1, 3, 17, 18, or 19.

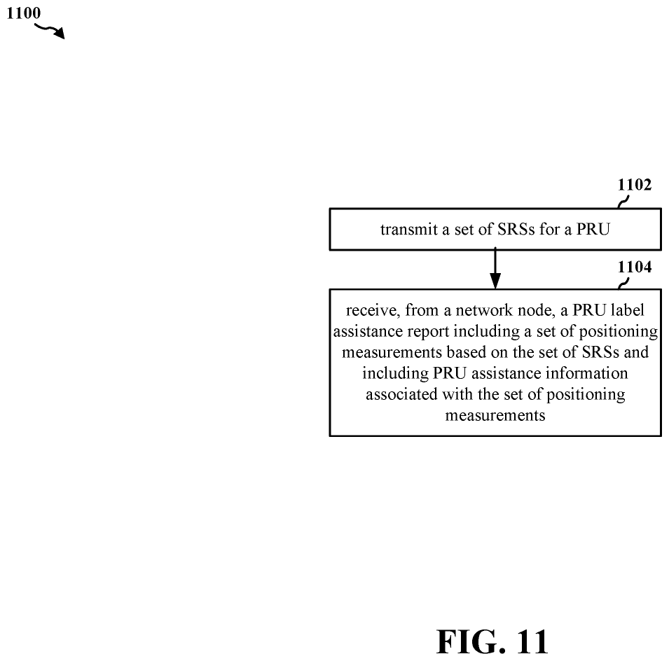

FIG. 11 is a flowchart 1100 of a method of wireless communication. The method may be performed by a UE (e.g., the UE 104, the UE 350; the wireless device 404; the UE/PRU 502; the set of UEs/PRUs 602; the PRU 504; the set of PRUs 702; the apparatus 1704). At 1102, the UE may transmit a set of SRSs for a PRU. For example, 1102 may be performed by the set of UEs/PRUs 602 in FIG. 6, which may transmit the set of SRSs 618 to the set of PRUs 604. Moreover, 1102 may be performed by the component 199 in FIG. 1, 3, or 17.

At 1104, the UE may receive, from a network node, a PRU label assistance report including a set of positioning measurements based on the set of SRSs and including PRU assistance information associated with the set of positioning measurements. For example, 1104 may be performed by the set of UEs/PRUs 602 in FIG. 6, which may receive, from the network entity 606, a set of PRU label assistance reports 630 including a set of positioning measurements based on the set of SRSs 618 and including PRU assistance information associated with the set of positioning measurements taken at 624. Moreover, 1104 may be performed by the component 199 in FIG. 1, 3, or 17.

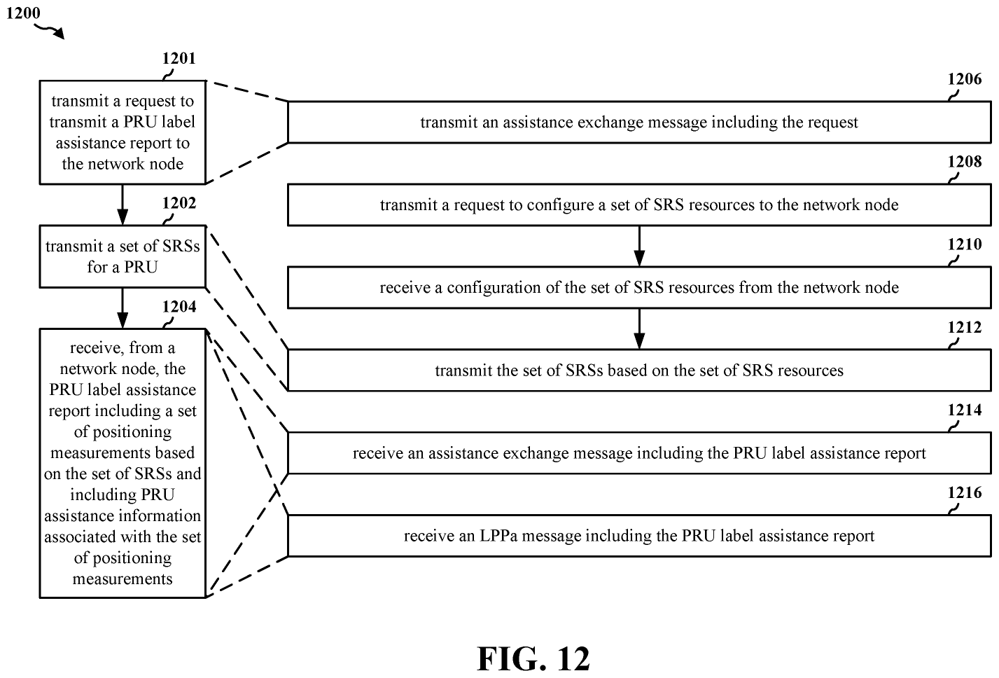

FIG. 12 is a flowchart 1200 of a method of wireless communication. The method may be performed by a UE (e.g., the UE 104, the UE 350; the wireless device 404; the UE/PRU 502; the set of UEs/PRUs 602; the PRU 504; the set of PRUs 702; the apparatus 1704). At 1201, the UE may transmit a request to transmit a PRU label assistance report to the network node. For example, 1201 may be performed by the set of UEs/PRUs 602 in FIG. 6, which may transmit a request 608 to transmit a PRU label assistance report to the network entity 606. Moreover, 1201 may be performed by the component 199 in FIG. 1, 3, or 17.

At 1202, the UE may transmit a set of SRSs for a PRU. For example, 1202 may be performed by the set of UEs/PRUs 602 in FIG. 6, which may transmit the set of SRSs 618 to the set of PRUs 604. Moreover, 1202 may be performed by the component 199 in FIG. 1, 3, or 17.

At 1204, the UE may receive, from a network node, a PRU label assistance report including a set of positioning measurements based on the set of SRSs and including PRU assistance information associated with the set of positioning measurements. For example, 1204 may be performed by the set of UEs/PRUs 602 in FIG. 6, which may receive, from the network entity 606, a set of PRU label assistance reports 630 including a set of positioning measurements based on the set of SRSs 618 and including PRU assistance information associated with the set of positioning measurements taken at 624. Moreover, 1204 may be performed by the component 199 in FIG. 1, 3, or 17.

At 1206, the UE may transmit an assistance exchange message including the request. For example, 1206 may be performed by the set of UEs/PRUs 602 in FIG. 6, which may transmit the request 608 as an assistance exchange message including the request. Moreover, 1206 may be performed by the component 199 in FIG. 1, 3, or 17.

At 1208, the UE may transmit a request to configure a set of SRS resources to the network node. For example, 1208 may be performed by the set of UEs/PRUs 602 in FIG. 6, which may transmit a request 608 to configure a set of SRS resources to the network entity 606. Moreover, 1208 may be performed by the component 199 in FIG. 1, 3, or 17.

At 1210, the UE may receive a configuration of the set of SRS resources from the network node. For example, 1210 may be performed by the set of UEs/PRUs 602 in FIG. 6, which may receive the set of PRS/SRS resource schedules 612 that may include a configuration of the set of SRS resources from the set of PRUs 604, or may receive the set of PRS/SRS resource schedules 614 that may include a configuration of the set of SRS resources from the network entity 606. Moreover, 1210 may be performed by the component 199 in FIG. 1, 3, or 17.

At 1212, the UE may transmit the set of SRSs based on the set of SRS resources. For example, 1212 may be performed by the set of UEs/PRUs 602 in FIG. 6, which may transmit the set of SRSs 618 based on the set of SRS resources of the set of PRS/SRS resource schedules 612 or the set of PRS/SRS resource schedules 614. Moreover, 1212 may be performed by the component 199 in FIG. 1, 3, or 17.

At 1214, the UE may receive an assistance exchange message including the PRU label assistance report. For example, 1214 may be performed by the set of UEs/PRUs 602 in FIG. 6, which may receive an assistance exchange message including the set of PRU label assistance reports 630 from the network entity 606. Moreover, 1214 may be performed by the component 199 in FIG. 1, 3, or 17.

At 1216, the UE may receive an LPPa message including the PRU label assistance report. For example, 1216 may be performed by the set of UEs/PRUs 602 in FIG. 6, which may receive an LPPa message including the set of PRU label assistance reports 630 from the network entity 606. Moreover, 1216 may be performed by the component 199 in FIG. 1, 3, or 17.

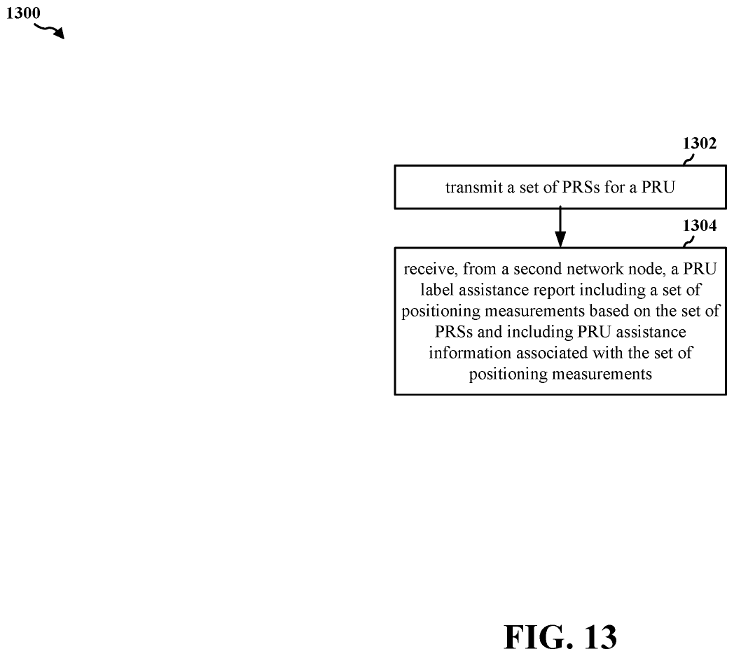

FIG. 13 is a flowchart 1300 of a method of wireless communication. The method may be performed by a first network node (e.g., the PRU 504; the set of PRUs 604, the base station 102, the base station 310; the wireless device 402, the wireless device 406; the TRP/PRU 506, the set of TRPs/PRUs 704; the network entity 606, the network entity 706; the network entity 1702, the network entity 1802, the network entity 1960). At 1302, the first network node may transmit a set of PRSs for a PRU. For example, 1302 may be performed by the set of TRPs/PRUs 704 in FIG. 7, which may transmit the set of PRSs 720 to the set of PRUs 702. Moreover, 1302 may be performed by the component 197 in FIG. 1, 3, 18, or 19.

At 1304, the first network node may receive, from a second network node, a PRU label assistance report including a set of positioning measurements based on the set of PRSs and including PRU assistance information associated with the set of positioning measurements. For example, 1304 may be performed by the set of TRPs/PRUs 704 in FIG. 7, which may receive, from the network entity 706, a set of PRU label assistance reports 730 including a set of positioning measurements based on the set of PRSs 720 and including PRU assistance information associated with the set of positioning measurements measured at 722. Moreover, 1304 may be performed by the component 197 in FIG. 1, 3, 18, or 19.

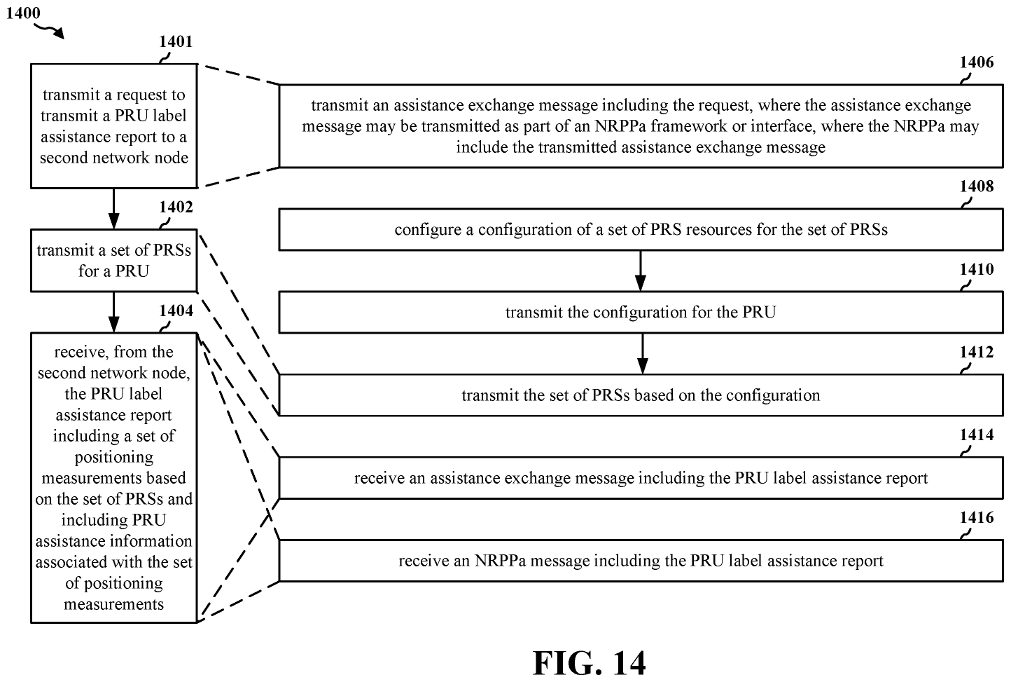

FIG. 14 is a flowchart 1400 of a method of wireless communication. The method may be performed by a first network node (e.g., the PRU 504; the set of PRUs 604, the base station 102, the base station 310; the wireless device 402, the wireless device 406; the TRP/PRU 506, the set of TRPs/PRUs 704; the network entity 606, the network entity 706; the network entity 1702, the network entity 1802, the network entity 1960). At 1401, the first network node may transmit a request to transmit a PRU label assistance report to a second network node. For example, 1401 may be performed by the set of TRPs/PRUs 704 in FIG. 7, which may transmit a request 708 to transmit a PRU label assistance report to the network entity 706. Moreover, 1401 may be performed by the component 197 in FIG. 1, 3, 18, or 19.

At 1402, the first network node may transmit a set of PRSs for a PRU. For example, 1402 may be performed by the set of TRPs/PRUs 704 in FIG. 7, which may transmit the set of PRSs 720 to the set of PRUs 702. Moreover, 1402 may be performed by the component 197 in FIG. 1, 3, 18, or 19.

At 1404, the first network node may receive, from the second network node, the PRU label assistance report including a set of positioning measurements based on the set of PRSs and including PRU assistance information associated with the set of positioning measurements. For example, 1404 may be performed by the set of TRPs/PRUs 704 in FIG. 7, which may receive, from the network entity 706, a set of PRU label assistance reports 730 including a set of positioning measurements based on the set of PRSs 720 and including PRU assistance information associated with the set of positioning measurements measured at 722. Moreover, 1404 may be performed by the component 197 in FIG. 1, 3, 18, or 19.

At 1406, the first network node may transmit an assistance exchange message including the request. The assistance exchange message may be transmitted as part of an NRPPa framework or interface. The NRPPa may include the transmitted assistance exchange message. For example, 1406 may be performed by the set of TRPs/PRUs 704 in FIG. 7, which may transmit the request 708 as an assistance exchange message including the request. The assistance exchange message may be transmitted as part of an NRPPa framework or interface. The NRPPa may include the transmitted assistance exchange message. Moreover, 1406 may be performed by the component 197 in FIG. 1, 3, 18, or 19.

At 1408, the first network node may configure a configuration of a set of PRS resources for the set of PRSs. For example, 1408 may be performed by the set of TRPs/PRUs 704 in FIG. 7, which may configure a configuration of a set of PRS resources for the set of PRSs 720. In another example, 1408 may be performed by the network entity 706, which may configure a configuration of a set of PRS resources for the set of PRSs 720. Moreover, 1408 may be performed by the component 197 in FIG. 1, 3, 18, or 19.

At 1410, the first network node may transmit the configuration for the PRU. For example, 1410 may be performed by the set of TRPs/PRUs 704 in FIG. 7, which may transmit the configuration as the set of PRS/SRS resource schedules 712 to the set of PRUs 702. In another example, 1410 may be performed by the network entity 706 in FIG. 7, which may transmit the configuration as the set of PRS/SRS resource schedules 714 to the set of PRUs 702. Moreover, 1410 may be performed by the component 197 in FIG. 1, 3, 18, or 19.

At 1412, the first network node may transmit the set of PRSs based on the configuration. For example, 1412 may be performed by the set of TRPs/PRUs 704 in FIG. 7, which may transmit the set of PRSs 720 at the set of PRUs 702 based on the configuration. Moreover, 1412 may be performed by the component 197 in FIG. 1, 3, 18, or 19.

At 1414, the first network node may receive an assistance exchange message including the PRU label assistance report. For example, 1414 may be performed by the network entity 706 in FIG. 7, which may receive an assistance exchange message including the set of PRU label assistance reports 726 from the set of PRUs 702. Moreover, 1414 may be performed by the component 197 in FIG. 1, 3, 18, or 19.

At 1416, the first network node may receive an NRPPa message including the PRU label assistance report. For example, 1416 may be performed by the network entity 706 in FIG. 7, which may receive an NRPPa message including the set of PRU label assistance/measurement reports 728. Moreover, 1416 may be performed by the component 197 in FIG. 1, 3, 18, or 19.

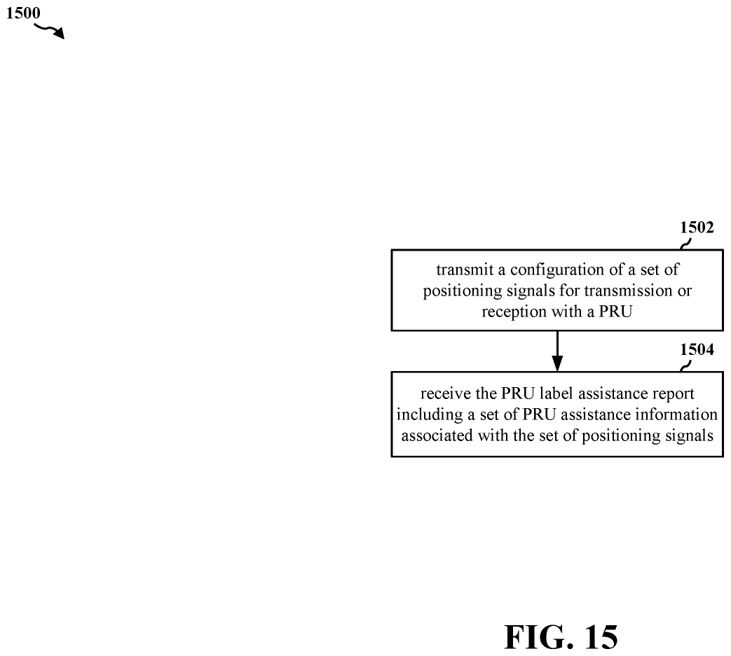

FIG. 15 is a flowchart 1500 of a method of wireless communication. The method may be performed by a first network node (e.g., the PRU 504; the set of PRUs 604, the base station 102, the base station 310; the wireless device 402, the wireless device 406; the TRP/PRU 506, the set of TRPs/PRUs 704; the network entity 606, the network entity 706; the network entity 1702, the network entity 1802, the network entity 1960). At 1502, the first network node may transmit a configuration of a set of positioning signals for transmission or reception with a PRU. For example, 1502 may be performed by the network entity 606 in FIG. 6, which may transmit the set of PRS/SRS resource schedules 610 to the set of PRUs 604. The set of PRS/SRS resource schedules 610 may include a configuration of the set of SRSs 618 for reception at the set of PRUs 604 and/or the set of PRSs 620 for transmission at the set of PRUs 604. In another example, 1502 may be performed by the network entity 706 in FIG. 7, which may transmit the set of PRS/SRS resource schedules 714 to the set of PRUs 702. The set of PRS/SRS resource schedules 714 may include a configuration of the set of SRSs 718 for transmission at the set of PRUs 702 and/or the set of PRSs 720 for reception at the set of PRUs 702. Moreover, 1502 may be performed by the component 197 in FIG. 1, 3, 18, or 19.

At 1504, the first network node may receive the PRU label assistance report including a set of PRU assistance information associated with the set of positioning signals. For example, 1504 may be performed by the network entity 606 in FIG. 6, which may receive the set of PRU label assistance reports 626 from the set of PRUs 604 including a set of PRU assistance information associated with the set of SRSs 618 and/or the set of PRSs 620. In another example, 1504 may be performed by the network entity 706 in FIG. 7, which may receive the set of PRU label assistance reports 726 from the set of PRUs 702 including a set of PRU assistance information associated with the set of SRSs 718 and/or the set of PRSs 720. Moreover, 1504 may be performed by the component 197 in FIG. 1, 3, 18, or 19.

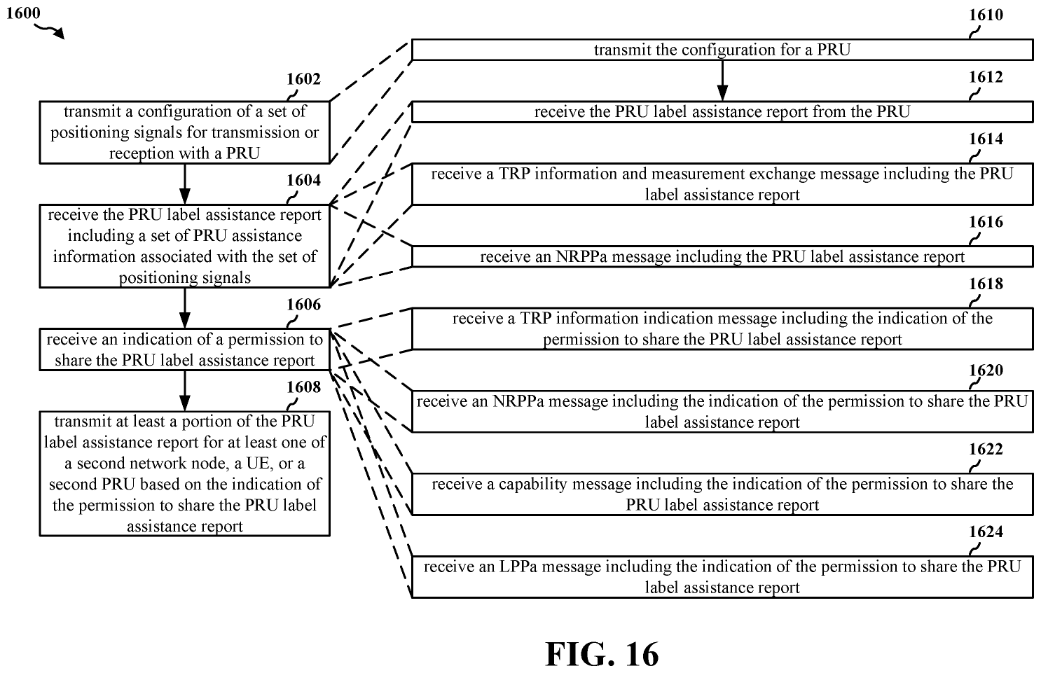

FIG. 16 is a flowchart 1600 of a method of wireless communication. The method may be performed by a first network node (e.g., the PRU 504; the set of PRUs 604, the base station 102, the base station 310; the wireless device 402, the wireless device 406; the TRP/PRU 506, the set of TRPs/PRUs 704; the network entity 606, the network entity 706; the network entity 1702, the network entity 1802, the network entity 1960). At 1602, the first network node may transmit a configuration of a set of positioning signals for transmission or reception with a PRU. For example, 1602 may be performed by the network entity 606 in FIG. 6, which may transmit the set of PRS/SRS resource schedules 610 to the set of PRUs 604. The set of PRS/SRS resource schedules 610 may include a configuration of the set of SRSs 618 for reception at the set of PRUs 604 and/or the set of PRSs 620 for transmission at the set of PRUs 604. In another example, 1602 may be performed by the network entity 706 in FIG. 7, which may transmit the set of PRS/SRS resource schedules 714 to the set of PRUs 702. The set of PRS/SRS resource schedules 714 may include a configuration of the set of SRSs 718 for transmission at the set of PRUs 702 and/or the set of PRSs 720 for reception at the set of PRUs 702. Moreover, 1602 may be performed by the component 197 in FIG. 1, 3, 18, or 19.

At 1604, the first network node may receive the PRU label assistance report including a set of PRU assistance information associated with the set of positioning signals. For example, 1604 may be performed by the network entity 606 in FIG. 6, which may receive the set of PRU label assistance reports 626 from the set of PRUs 604 including a set of PRU assistance information associated with the set of SRSs 618 and/or the set of PRSs 620. In another example, 1604 may be performed by the network entity 706 in FIG. 7, which may receive the set of PRU label assistance reports 726 from the set of PRUs 702 including a set of PRU assistance information associated with the set of SRSs 718 and/or the set of PRSs 720. Moreover, 1604 may be performed by the component 197 in FIG. 1, 3, 18, or 19.

At 1606, the first network node may receive an indication of a permission to share the PRU label assistance report. For example, 1606 may be performed by the network entity 606 in FIG. 6, which may receive the indication 616 of the permission to share a PRU label assistance report from the set of PRUs 604. In another example, 1606 may be performed by the network entity 706 in FIG. 7, which may receive the indication 716 of a permission to share the PRU label assistance report from the set of PRUs 702. Moreover, 1606 may be performed by the component 197 in FIG. 1, 3, 18, or 19.

At 1608, the first network node may transmit at least a portion of the PRU label assistance report for at least one of a second network node, a UE, or a second PRU based on the indication of the permission to share the PRU label assistance report. For example, 1608 may be performed by the network entity 606 in FIG. 6, which may transmit at least a portion of the set of PRU label assistance reports 626 for the set of UEs/PRUs 602 based on the indication 616 of the permission to share the PRU label assistance report. In another example, 1608 may be performed by the network entity 706 in FIG. 7, which may transmit at least a portion of the set of PRU label assistance reports 730 for the set of TRPs/PRUs 704 based on the indication 716 of the permission to share the PRU label assistance report. Moreover, 1608 may be performed by the component 197 in FIG. 1, 3, 18, or 19.

At 1610, the first network node may transmit the configuration for a PRU. For example, 1610 may be performed by the network entity 606 in FIG. 6, which may transmit the configuration as the set of PRS/SRS resource schedules 610 for the set of PRUs 604. In another example, 1610 may be performed by the network entity 706 in FIG. 7, which may transmit the configuration as the set of PRS/SRS resource schedules 714 for the set of PRUs 702. Moreover, 1610 may be performed by the component 197 in FIG. 1, 3, 18, or 19.

At 1612, the first network node may receive the PRU label assistance report from the PRU. For example, 1612 may be performed by the network entity 606 in FIG. 6, which may receive the set of PRU label assistance reports 626 from the set of PRUS 604. In another example, 1612 may be performed by the network entity 706 in FIG. 7, which may receive the set of PRU label assistance reports 726 from the set of PRUs 702. Moreover, 1612 may be performed by the component 197 in FIG. 1, 3, 18, or 19.

At 1614, the first network node may receive a TRP information and measurement exchange message including the PRU label assistance report. For example, 1614 may be performed by the network entity 606 in FIG. 6, which may receive a TRP information and measurement exchange message including the set of PRU label assistance reports 626 from the set of PRUs 604. In another example, 1614 may be performed by the network entity 706 in FIG. 7, which may receive a TRP information and measurement exchange message including the set of PRU label assistance/measurement reports 728 from the set of TRPs/PRUs 704. Moreover, 1614 may be performed by the component 197 in FIG. 1, 3, 18, or 19.

At 1616, the first network node may receive an NRPPa message including the PRU label assistance report. For example, 1616 may be performed by the network entity 606 in FIG. 6, which may receive an NRPPa message including the set of PRU label assistance reports 626 from the set of PRUs 604. In another example, 1616 may be performed by the network entity 706 in FIG. 7, which may receive an NRPPa message including the set of PRU label assistance reports 726 from the set of TRPs/PRUs 704. Moreover, 1616 may be performed by the component 197 in FIG. 1, 3, 18, or 19.

At 1618, the first network node may receive a TRP information indication message including the indication of the permission to share the PRU label assistance report. For example, 1618 may be performed by the network entity 606 in FIG. 6, which may receive a TRP information indication message including the indication 616 of the permission to share the PRU label assistance report. In another example, 1618 may be performed by the network entity 706 in FIG. 7, which may receive a TRP information indication message including the indication 716 of the permission to share the PRU label assistance report. Moreover, 1618 may be performed by the component 197 in FIG. 1, 3, 18, or 19.

At 1620, the first network node may receive an NRPPa message including the indication of the permission to share the PRU label assistance report. For example, 1620 may be performed by the network entity 606 in FIG. 6, which may receive an NRPPa message including the indication 616 of the permission to share the PRU label assistance report. In another example, 1620 may be performed by the network entity 706 in FIG. 7, which may receive an NRPPa message including the indication 716 of the permission to share the PRU label assistance report. Moreover, 1620 may be performed by the component 197 in FIG. 1, 3, 18, or 19.

At 1622, the first network node may receive a capability message including the indication of the permission to share the PRU label assistance report. For example, 1622 may be performed by the network entity 606 in FIG. 6, which may receive a capability message including the indication 616 of the permission to share the PRU label assistance report. In another example, 1622 may be performed by the network entity 706 in FIG. 7, which may receive a capability message including the indication 716 of the permission to share the PRU label assistance report. Moreover, 1622 may be performed by the component 197 in FIG. 1, 3, 18, or 19.

At 1624, the first network node may receive an LPPa message including the indication of the permission to share the PRU label assistance report. For example, 1624 may be performed by the network entity 606 in FIG. 6, which may receive an LPPa message including the indication 616 of the permission to share the PRU label assistance report. In another example, 1624 may be performed by the network entity 706 in FIG. 7, which may receive an LPPa message including the indication 716 of the permission to share the PRU label assistance report. Moreover, 1624 may be performed by the component 197 in FIG. 1, 3, 18, or 19.

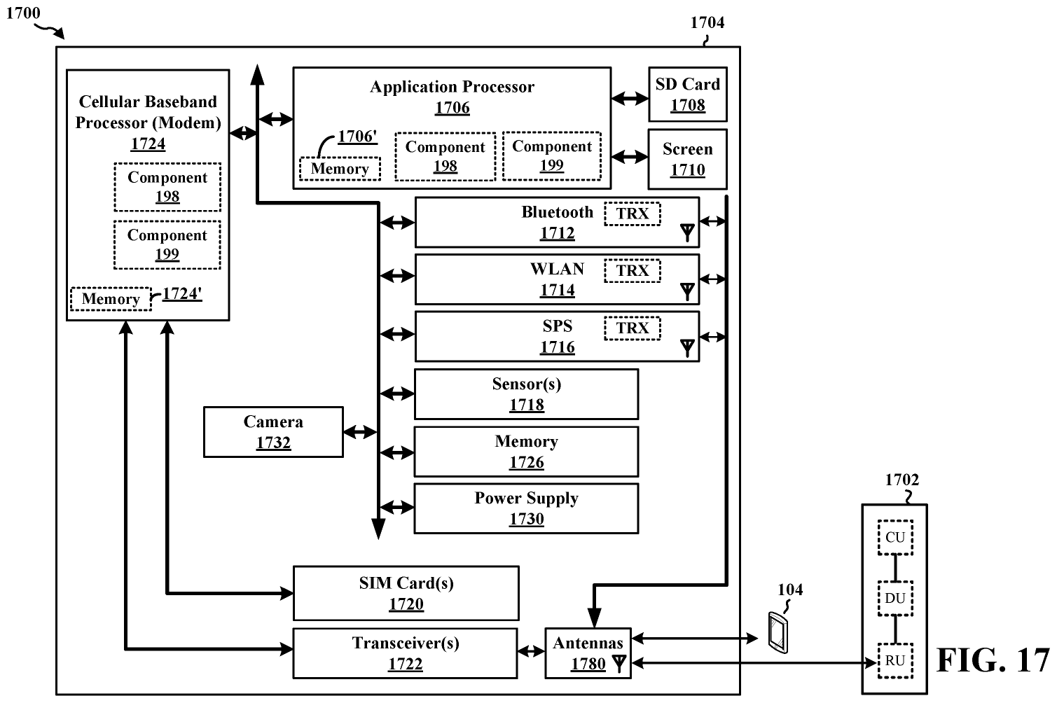

FIG. 17 is a diagram 1700 illustrating an example of a hardware implementation for an apparatus 1704. The apparatus 1704 may be a UE, a component of a UE, or may implement UE functionality. In some aspects, the apparatus 1404 may include a cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor 1724 communicates through the transceiver(s) 1722 via one or more antennas 1780 with the UE 104 and/or with an RU associated with a network entity 1702. The cellular baseband processor 1724 and the application processor 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described supra. The computer-readable medium/memory may also be used for storing data that is manipulated by the cellular baseband processor 1724/application processor 1706 when executing software. The cellular baseband processor 1724/application processor 1706 may be a component of the UE 350 and may include the memory 360 and/or at least one of the TX processor 368, the RX processor 356, and the controller/processor 359. In one configuration, the apparatus 1704 may be a processor chip (modem and/or application) and include just the cellular baseband processor 1724 and/or the application processor 1706, and in another configuration, the apparatus 1704 may be the entire UE (e.g., see UE 350 of FIG. 3) and include the additional modules of the apparatus 1704.

As discussed supra, the component 198 may be configured to receive a set of positioning signals from at least one of a UE, a first network node, or a PRU. The component 198 may be configured to measure the set of positioning signals. The component 198 may be configured to transmit, for the first network node or a second network node, a PRU label assistance report. The PRU label assistance report may include a set of positioning measurements based on the measured set of positioning signals. The PRU label assistance report may include PRU assistance information associated with measuring the set of positioning signals. The component 198 may be within the cellular baseband processor 1724, the application processor 1706, or both the cellular baseband processor 1724 and the application processor 1706. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1704 may include a variety of components configured for various functions. In one configuration, the apparatus 1704, and in particular the cellular baseband processor 1724 and/or the application processor 1706, may include means for receiving a set of positioning signals from at least one of a UE, a first network node, or a PRU. The means may be the component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

As discussed supra, the component 199 may be configured to transmit a set of SRSs for a PRU. The component 199 may be configured to receive, from a network node, a PRU label assistance report. The PRU label assistance report may include a set of positioning measurements based on the set of SRSs. The PRU label assistance report may include PRU assistance information associated with the set of positioning measurements. The component 199 may be within the cellular baseband processor 1724, the application processor 1706, or both the cellular baseband processor 1724 and the application processor 1706. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1704 may include a variety of components configured for various functions. In one configuration, the apparatus 1704, and in particular the cellular baseband processor 1724 and/or the application processor 1706, may include means for transmitting a set of SRSs for a PRU. The means may be the component 199 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

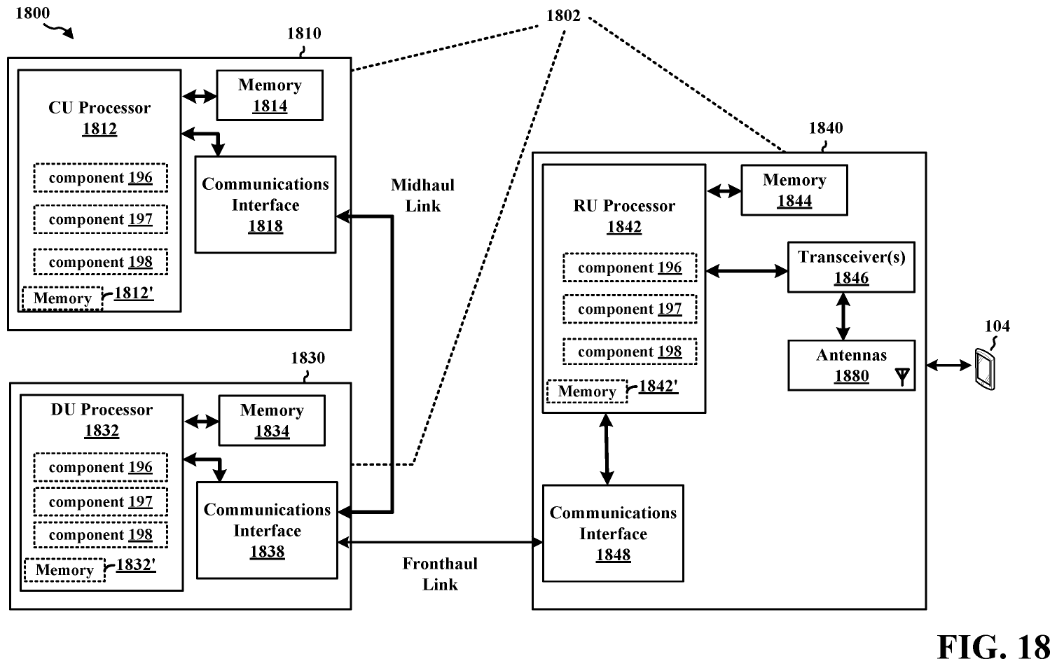

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include a CU processor 1812. The CU processor 1812 may include on-chip memory 1812′. In some aspects, the CU 1810 may further include additional memory modules 1814 and a communications interface 1818. The CU 1810 communicates with the DU 1830 through a midhaul link, such as an F1 interface. The DU 1830 may include a DU processor 1832. The DU processor 1832 may include on-chip memory 1832′. In some aspects, the DU 1830 may further include additional memory modules 1834 and a communications interface 1838. The DU 1830 communicates with the RU 1840 through a fronthaul link. The RU 1840 may include an RU processor 1842. The RU processor 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 198 may be configured to receive a set of positioning signals from at least one of a UE, a first network node, or a PRU. The component 198 may be configured to measure the set of positioning signals. The component 198 may be configured to transmit, for the first network node or a second network node, a PRU label assistance report. The PRU label assistance report may include a set of positioning measurements based on the measured set of positioning signals. The PRU label assistance report may include PRU assistance information associated with measuring the set of positioning signals. The component 198 may be within one or more processors of one or more of the CU 1810, DU 1830, and the RU 1840. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1802 may include a variety of components configured for various functions. In one configuration, the network entity 1802 may include means for receiving a set of positioning signals from at least one of a UE, a first network node, or a PRU. The means may be the component 198 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

As discussed supra, the component 197 may be configured to transmit a set of PRSs for a PRU. The component 197 may be configured to receive, from a second network node, such as the LMF 166, a PRU label assistance report. The PRU label assistance report may include a set of positioning measurements based on the set of PRSs. The PRU label assistance report may include PRU assistance information associated with the set of positioning measurements. The component 197 may be within one or more processors of one or more of the CU 1810, DU 1830, and the RU 1840. The component 197 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1802 may include a variety of components configured for various functions. In one configuration, the network entity 1802 may include means for transmitting a set of PRSs for a PRU. The means may be the component 197 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

As discussed supra, the component 196 may be configured to transmit a request for a PRU label assistance report to a PRU associated with a set of positioning signals transmitted or received with the PRU. The component 196 may receive the PRU label assistance report including a set of PRU assistance information associated with the set of positioning signals. The component 196 may be within one or more processors of one or more of the CU 1810, DU 1830, and the RU 1840. The component 196 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1802 may include a variety of components configured for various functions. In one configuration, the network entity 1802 may include means for transmitting a request for a PRU label assistance report to a PRU associated with a set of positioning signals transmitted or received with the PRU. The means may be the component 196 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

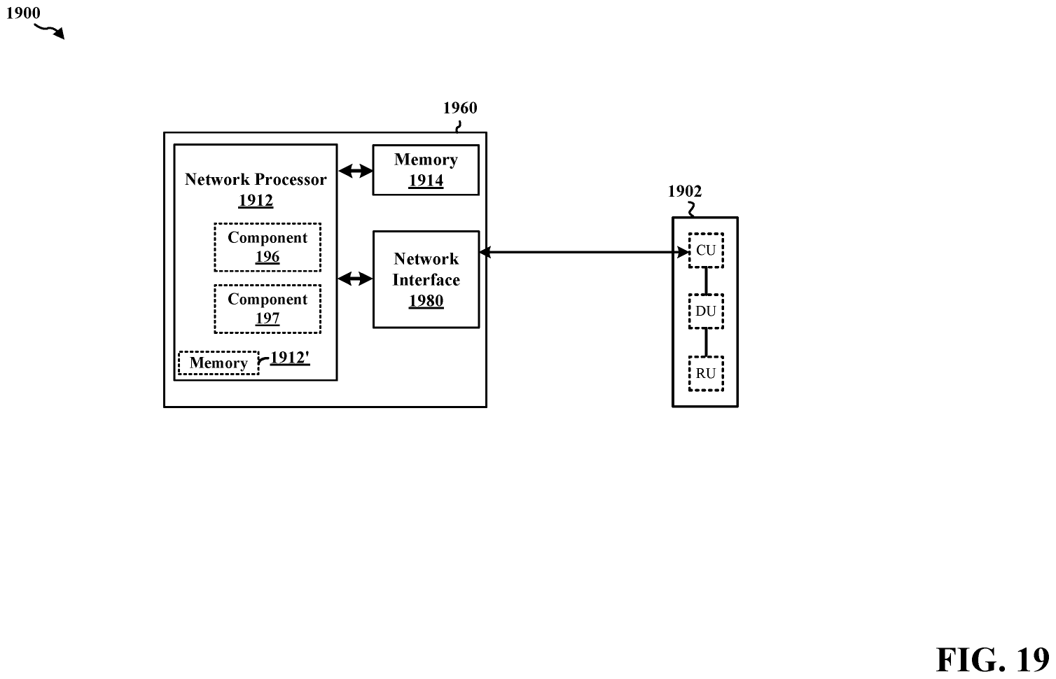

FIG. 19 is a diagram 1900 illustrating an example of a hardware implementation for a network entity 1960. In one example, the network entity 1960 may be within the core network 120. The network entity 1960 may include a network processor 1912. The network processor 1912 may include on-chip memory 1912′. In some aspects, the network entity 1960 may further include additional memory modules 1914. The network entity 1960 communicates via the network interface 1980 directly (e.g., backhaul link) or indirectly (e.g., through a RIC) with the CU 1902. The on-chip memory 1912′ and the additional memory modules 1914 may each be considered a computer-readable medium/memory. Each computer-readable medium/memory may be non-transitory. The processor 1912 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 197 may be configured to transmit a set of PRSs for a PRU. The component 197 may be configured to receive, from a second network node, such as the LMF 166, a PRU label assistance report. The PRU label assistance report may include a set of positioning measurements based on the set of PRSs. The PRU label assistance report may include PRU assistance information associated with the set of positioning measurements. The component 197 may be within the processor 1912. The component 197 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1960 may include a variety of components configured for various functions. In one configuration, the network entity 1960 may include means for transmitting a set of PRSs for a PRU. The means may be the component 197 of the network entity 1960 configured to perform the functions recited by the means.

As discussed supra, the component 196 may be configured to transmit a request for a PRU label assistance report to a PRU associated with a set of positioning signals transmitted or received with the PRU. The component 196 may receive the PRU label assistance report including a set of PRU assistance information associated with the set of positioning signals. The component 196 may be within the processor 1912. The component 196 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1960 may include a variety of components configured for various functions. In one configuration, the network entity 1960 may include means for transmitting a request for a PRU label assistance report to a PRU associated with a set of positioning signals transmitted or received with the PRU. The means may be the component 196 of the network entity 1960 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive the data, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a wireless device, where the method may include receiving a set of positioning signals from at least one of a UE, a first network node, or a PRU. The method may include measuring the set of positioning signals. The method may include transmitting, for the first network node or a second network node, a PRU label assistance report. The PRU label assistance report may include a set of positioning measurements based on the measured set of positioning signals. The PRU label assistance report may include PRU assistance information associated with measuring the set of positioning signals.

Aspect 2 is the method of aspect 1, where the PRU assistance information may include at least one of (a) a first indication of a location of at least one PRU, (b) a second indication of a beam angle associated with the set of positioning signals, (c) a third indication of an antenna orientation associated with receiving the set of positioning signals, (d) a fourth indication of a group delay associated with the set of positioning measurements, (e) a fifth indication of a sensor measurement associated with the set of positioning measurements, (f) a sixth indication of a sensor type associated with at least one PRU, (g) a seventh indication of a synchronization error associated with the set of positioning measurements, (h) an eighth indication of a timing error associated with the set of positioning measurements, or (i) a ninth indication of a clock drift range associated with the set of positioning measurements.

Aspect 3 is the method of either of aspects 1 or 2, where transmitting the PRU label assistance report may include transmitting a TRP information and measurement exchange message including the PRU label assistance report.

Aspect 4 is the method of any of aspects 1 to 3, where transmitting the PRU label assistance report may include transmitting an NRPPa message including the PRU label assistance report.

Aspect 5 is the method of any of aspects 1 to 4, where the method may include transmitting, for at least one of the first network node or the second network node, an indication of a permission to share the PRU label assistance report.

Aspect 6 is the method of aspect 5, where the permission to share the PRU label assistance report may include at least one of (a) a set of UE IDs associated with a set of UEs authorized to receive the PRU label assistance report, (b) a first indication of a UE vendor associated with a first set of UEs authorized to receive the PRU label assistance report, (c) a second indication of a UE chip vendor associated with a second set of UEs authorized to receive the PRU label assistance report, (d) a set of TRP IDs associated with TRPs authorized to receive the PRU label assistance report, (e) a third indication of a NW operator associated with a first set of TRPs authorized to receive the PRU label assistance report, or (f) a fourth indication of a NW vendor associated with a second set of TRPs authorized to receive the PRU label assistance report.

Aspect 7 is the method of either of aspects 5 or 6, where transmitting the indication of the permission to share the PRU label assistance report may include transmitting a TRP information indication message including the indication of the permission to share the PRU label assistance report.

Aspect 8 is the method of any of aspects 5 to 7, where transmitting the indication of the permission to share the PRU label assistance report may include transmitting an NRPPa message including the indication of the permission to share the PRU label assistance report.

Aspect 9 is the method of any of aspects 5 to 8, where transmitting the indication of the permission to share the PRU label assistance report may include transmitting a capability message including the indication of the permission to share the PRU label assistance report.

Aspect 10 is the method of any of aspects 5 to 9, where transmitting the indication of the permission to share the PRU label assistance report may include transmitting an LPPa message including the indication of the permission to share the PRU label assistance report.

Aspect 11 is the method of any of aspects 1 to 10, where the method may include receiving, from at least one of the first network node or the second network node, a configuration of the set of positioning signals. Receiving the set of positioning signals may be based on the configuration.

Aspect 12 is the method of any of aspects 1 to 11, where the method may include receiving, from at least one of the first network node or the second network node, a request to transmit the PRU label assistance report. Transmitting the PRU label assistance report may be in response to receiving the request.

Aspect 13 is the method of any of aspects 1 to 12, where the wireless device may include a second PRU.

Aspect 14 is the method of any of aspects 1 to 13, where at least one of the first network node or the second network node may include an LMF.

Aspect 15 is the method of any of aspects 1 to 14, where the set of positioning signals may include at least one of a PRS or an SRS.

Aspect 16 is the method of any of aspects 1 to 15, where the method may include transmitting a second set of positioning signals to at least one of the UE, the first network node, or the PRU. The method may include transmitting, for at least one the first network node or the second network node, a second PRU assistance information associated with the second set of positioning signals.

Aspect 17 is the method of aspect 16, where the second set of positioning signals may include at least one of a PRS or an SRS.

Aspect 18 is the method of either of aspects 16 or 17, where the second PRU assistance information may include at least one of (a) a first indication of a location of at least one PRU, (b) a second indication of a beam angle associated with the second set of positioning signals, (c) a third indication of an antenna orientation associated with transmitting the second set of positioning signals, (d) a fourth indication of a group delay associated with the second set of positioning signals, (e) a fifth indication of a synchronization error associated with the second set of positioning signals, (f) a sixth indication of a timing error associated with the second set of positioning signals, or (g) a seventh indication of a clock drift range associated with the second set of positioning signals.

Aspect 19 is a method of wireless communication at a UE, where the method may include transmitting a set of SRSs for a PRU. The method may include receiving, from a network node, a PRU label assistance report. The PRU label assistance report may include a set of positioning measurements based on the set of SRSs. The PRU label assistance report may include PRU assistance information associated with the set of positioning measurements.

Aspect 20 is the method of aspect 19, where the PRU assistance information may include at least one of (a) a first indication of a location of at least one PRU, (b) a second indication of a beam angle associated with the set of SRSs, (c) a third indication of an antenna orientation associated with receiving the set of SRSs, (d) a fourth indication of a group delay associated with the set of positioning measurements, (e) a fifth indication of a sensor measurement associated with the set of positioning measurements, (f) a sixth indication of a sensor type associated with at least one PRU, (g) a seventh indication of a synchronization error associated with the set of positioning measurements, (h) an eighth indication of a timing error associated with the set of positioning measurements, or (i) a ninth indication of a clock drift range associated with the set of positioning measurements.

Aspect 21 is a method of wireless communication at a network node, where receiving the PRU label assistance report from the network node may include receiving an assistance exchange message including the PRU label assistance report.

Aspect 22 is the method of any of aspects 19 to 21, where receiving the PRU label assistance report from the network node may include receiving an LPPa message including the PRU label assistance report.

Aspect 23 is the method of any of aspects 19 to 22, where the method may include transmitting a request to transmit the PRU label assistance report to the network node.

Aspect 24 is the method of aspect 23, where the method may include transmitting an assistance exchange message including the request.

Aspect 25 is the method of any of aspects 19 to 24, where the method may include transmitting a request to configure a set of SRS resources to the network node. The method may include receiving a configuration of the set of SRS resources from the network node. Transmitting the set of SRSs to the PRU may include transmitting the set of SRSs based on the set of SRS resources.

Aspect 26 is the method of any of aspects 19 to 25, where the method may include receiving a set of PRSs from the PRU. The method may include measuring the set of PRSs. The method may include calculating a position of the UE based on the measured set of PRSs and the set of positioning measurements.

Aspect 27 is the method of aspect 26, where the method may include receiving, from the network node, a second PRU assistance information associated with the set of PRSs. Calculating the position of the UE may be further based on the second PRU assistance information. Receiving the second PRU assistance information may include receiving a PRU label assistance report including the second PRU assistance information.

Aspect 28 is the method of aspect 27, where the second PRU assistance information may include at least one of (a) a first indication of a location of at least one PRU, (b) a second indication of a beam angle associated with the set of PRSs, (c) a third indication of an antenna orientation associated with transmitting the set of PRSs, (d) a fourth indication of a group delay associated with the set of PRSs, (e) a fifth indication of a synchronization error associated with the set of PRSs, (f) a sixth indication of a timing error associated with the set of PRSs, or (g) a seventh indication of a clock drift range associated with the set of PRSs.

Aspect 29 is a method of wireless communication at a first network node, where the method may include transmitting a set of PRSs for a PRU. The method may include receiving, from a second network node, a PRU label assistance report. The PRU label assistance report may include a set of positioning measurements based on the set of PRSs. The PRU label assistance report may include PRU assistance information associated with the set of positioning measurements.

Aspect 30 is the method of aspect 29, where the PRU assistance information may include at least one of (a) a first indication of a location of at least one PRU, (b) a second indication of a beam angle associated with the set of PRSs, (c) a third indication of an antenna orientation associated with receiving the set of PRSs, (d) a fourth indication of a group delay associated with the set of positioning measurements, (e) a fifth indication of a sensor measurement associated with the set of positioning measurements, (f) a sixth indication of a sensor type associated with at least one PRU, (g) a seventh indication of a synchronization error associated with the set of positioning measurements, (h) an eighth indication of a timing error associated with the set of positioning measurements, or (i) a ninth indication of a clock drift range associated with the set of positioning measurements.

Aspect 31 is a method of either of aspects 29 or 30, where receiving the PRU label assistance report from the second network node may include receiving an assistance exchange message including the PRU label assistance report.

Aspect 32 is the method of any of aspects 29 to 31, where receiving the PRU label assistance report from the second network node may include receiving an NRPPa message including the PRU label assistance report.

Aspect 33 is the method of any of aspects 29 to 32, where the method may include transmitting a request to transmit the PRU label assistance report to the second network node.

Aspect 34 is the method of aspect 33, where transmitting the request may include transmitting an assistance exchange message including the request. The assistance exchange messages may be transmitted as part of an NRPPa framework or interface. The NRPPa may include the transmitted assistance exchange message.

Aspect 35 is the method of any of aspects 29 to 34, where the method may include configuring a configuration of a set of PRS resources for the set of PRSs. The method may include transmitting the configuration for the PRU. Transmitting the set of PRSs may include transmitting the set of PRSs based on the configuration.

Aspect 36 is the method of any of aspects 29 to 35, where the method may include receiving a set of SRSs from the PRU. The method may include measuring the set of SRSs. The method may include calculating a position of the PRU based on the measured set of SRSs and the set of positioning measurements.

Aspect 37 is the method of aspect 36, where the method may include receiving, from the second network node, a second PRU assistance information associated with the set of SRSs. Calculating the position of the PRU may be further based on the second PRU assistance information.

Aspect 38 is the method of aspect 37, where the second PRU assistance information may include at least one of (a) a first indication of a location of at least one PRU, (b) a second indication of a beam angle associated with the set of SRSs, (c) a third indication of an antenna orientation associated with transmitting the set of SRSs, (d) a fourth indication of a group delay associated with the set of SRSs, (e) a fifth indication of a synchronization error associated with the set of SRSs, (f) a sixth indication of a timing error associated with the set of SRSs, or (g) a seventh indication of a clock drift range associated with the set of SRSs.

Aspect 39 is the method of any of aspects 29 to 38, where the second network node may include an LMF.

Aspect 40 is a method of wireless communication at a network node, where the method may include transmitting a configuration of a set of positioning signals for transmission or reception with a PRU. The method may include receiving the PRU label assistance report including a set of PRU assistance information associated with the set of positioning signals.

Aspect 41 is the method of aspect 40, where the PRU label assistance report may include a set of positioning measurements based on the set of positioning signals.

Aspect 42 is the method of either of aspects 40 or 41, where the PRU assistance information may include at least one of (a) a first indication of a location of at least one PRU, (b) a second indication of a beam angle associated with the set of positioning, (c) a third indication of a first antenna orientation associated with transmitting the set of positioning signals, (d) a fourth indication of a second antenna orientation associated with receiving the set of positioning signals, (e) a fifth indication of a group delay associated with the set of positioning signals, (f) a sixth indication of a sensor measurement associated with a measurement of the set of positioning signals, (g) a seventh indication of a sensor type associated with at least one PRU, (h) an eighth indication of a synchronization error associated with the set of positioning signals, (i) a ninth indication of a timing error associated with the set of positioning signals, or (j) a tenth indication of a clock drift range associated with the set of positioning signals.

Aspect 43 is the method of any of aspects 40 to 42, where receiving the PRU label assistance report may include receiving a TRP information and measurement exchange message including the PRU label assistance report. Receiving the PRU label assistance report may include receiving an assistance data exchange message including the PRU label assistance report.

Aspect 44 is the method of any of aspects 40 to 43, where receiving the PRU label assistance report may include receiving an NRPPa message including the PRU label assistance report. Receiving the PRU label assistance report may include receiving an LPPa message including the PRU label assistance report.

Aspect 45 is the method of any of aspects 40 to 44, where the method may include receiving an indication of a permission to share the PRU label assistance report.

Aspect 46 is the method of aspect 45, where the permission to share the PRU label assistance report may include at least one of (a) a set of UE IDs associated with a set of UEs authorized to receive the PRU label assistance report, (b) a first indication of a UE vendor associated with a first set of UEs authorized to receive the PRU label assistance report, (c) a second indication of a UE chip vendor associated with a second set of UEs authorized to receive the PRU label assistance report, (d) a set of TRP IDs associated with TRPs authorized to receive the PRU label assistance report, (e) a third indication of a NW operator associated with a first set of TRPs authorized to receive the PRU label assistance report, or (f) a fourth indication of a NW vendor associated with a second set of TRPs authorized to receive the PRU label assistance report.

Aspect 47 is the method of aspect 45, where receiving the indication of the permission to share the PRU label assistance report may include receiving a TRP information indication message including the indication of the permission to share the PRU label assistance report.

Aspect 48 is the method of either 45 or 47, where receiving the indication of the permission to share the PRU label assistance report may include receiving an NRPPa message including the indication of the permission to share the PRU label assistance report.

Aspect 49 is the method of any of aspects 45, 47, or 48, where receiving the indication of the permission to share the PRU label assistance report may include receiving a capability message including the indication of the permission to share the PRU label assistance report.

Aspect 50 is the method of any of aspects 45 or 47 to 49, where receiving the indication of the permission to share the PRU label assistance report may include receiving an LPPa message including the indication of the permission to share the PRU label assistance report.

Aspect 51 is the method of any of aspects 45 or 47 to 50, where the method may include transmitting at least a portion of the PRU label assistance report for at least one of a second network node, a UE, or a second PRU based on the indication of the permission to share the PRU label assistance report.

Aspect 52 is the method of any of aspects 40 to 51, where the method may include transmitting a configuration of the set of positioning signals. The set of positioning signals may be transmitted or received with the PRU based on the configuration.

Aspect 53 is the method of any of aspects 40 to 52, where transmitting the request may include transmitting the request for a PRU. Receiving the PRU label assistance report may include receiving the PRU label assistance report from the PRU.

Aspect 54 is the method of any of aspects 40 to 53, where the network node may include an LMF.

Aspect 55 is the method of any of aspects 40 to 54, where the set of positioning signals may include at least one of a PRS or an SRS.

Aspect 56 is an apparatus for wireless communication, including: a memory; and at least one processor coupled to the memory and, based at least in part on information stored in the memory, the at least one processor is configured to implement any of aspects 1 to 55.

Aspect 57 is the apparatus of aspect 56, further including at least one of an antenna or a transceiver coupled to the at least one processor.

Aspect 58 is an apparatus for wireless communication including means for implementing any of aspects 1 to 55.

Aspect 59 is a computer-readable medium (e.g., a non-transitory computer-readable medium) storing computer executable code, where the code when executed by a processor causes the processor to implement any of aspects 1 to 55.

What is claimed is:

1. An apparatus for wireless communication at a wireless device, comprising:
a memory; and
at least one processor coupled to the memory and, based at least in part on information stored in the memory, the at least one processor is configured to:
receive a set of positioning signals from at least one of a user equipment (UE), a first network node, or a positioning reference unit (PRU);
measure the set of positioning signals; and
transmit, for the first network node or a second network node, a PRU label assistance report comprising a set of positioning measurements based on the measured set of positioning signals and comprising PRU assistance information associated with measuring the set of positioning signals.

2. The apparatus of claim 1, wherein the PRU assistance information comprises at least one of:
a first indication of a location of at least one PRU;
a second indication of a beam angle associated with the set of positioning signals;
a third indication of an antenna orientation associated with receiving the set of positioning signals;
a fourth indication of a group delay associated with the set of positioning measurements;
a fifth indication of a sensor measurement associated with the set of positioning measurements;
a sixth indication of a sensor type associated with at least one PRU;
a seventh indication of a synchronization error associated with the set of positioning measurements;
an eighth indication of a timing error associated with the set of positioning measurements; or
a ninth indication of a clock drift range associated with the set of positioning measurements.

3. The apparatus of claim 1, further comprising a transceiver coupled to the at least one processor, wherein, to transmit the PRU label assistance report, the at least one processor is configured to:
transmit, via the transceiver, a transmission reception point (TRP) information and measurement exchange message comprising the PRU label assistance report.

4. The apparatus of claim 1, wherein, to transmit the PRU label assistance report, the at least one processor is configured to:
transmit a new radio (NR) positioning protocol (NRPP) annex (NRPPa) message comprising the PRU label assistance report.

5. The apparatus of claim 1, wherein the at least one processor is further configured to:
transmit, for at least one of the first network node or the second network node, an indication of a permission to share the PRU label assistance report.

6. The apparatus of claim 5, wherein the permission to share the PRU label assistance report comprises at least one of:
a set of UE identifiers (IDs) associated with a set of UEs authorized to receive the PRU label assistance report;
a first indication of a UE vendor associated with a first set of UEs authorized to receive the PRU label assistance report;
a second indication of a UE chip vendor associated with a second set of UEs authorized to receive the PRU label assistance report;
a set of transmission reception point (TRP) identifiers (IDs) associated with TRPs authorized to receive the PRU label assistance report;
a third indication of a network (NW) operator associated with a first set of TRPs authorized to receive the PRU label assistance report; or
a fourth indication of a NW vendor associated with a second set of TRPs authorized to receive the PRU label assistance report.

7. The apparatus of claim 5, wherein, to transmit the indication of the permission to share the PRU label assistance report, the at least one processor is configured to:
transmit a transmission reception point (TRP) information indication message comprising the indication of the permission to share the PRU label assistance report.

8. The apparatus of claim 5, wherein, to transmit the indication of the permission to share the PRU label assistance report, the at least one processor is configured to:
transmit a new radio (NR) positioning protocol (NRPP) annex (NRPPa) message comprising the indication of the permission to share the PRU label assistance report.

9. The apparatus of claim 5, wherein, to transmit the indication of the permission to share the PRU label assistance report, the at least one processor is configured to:
transmit a capability message comprising the indication of the permission to share the PRU label assistance report.

10. The apparatus of claim 5, wherein, to transmit the indication of the permission to share the PRU label assistance report, the at least one processor is configured to:
transmit a long term evolution (LTE) positioning protocol (LPP) annex (LPPa) message comprising the indication of the permission to share the PRU label assistance report.

11. The apparatus of claim 1, wherein the at least one processor is further configured to:
receive, from at least one of the first network node or the second network node, a configuration of the set of positioning signals, wherein, to receive the set of positioning signals, the at least one processor is configured to receive the set of positioning signals based on the configuration.

12. The apparatus of claim 1, wherein the at least one processor is further configured to:
receive, from at least one of the first network node or the second network node, a request to transmit the PRU label assistance report, wherein, to transmit the PRU label assistance report, the at least one processor is configured to transmit the PRU label assistance report in response to receiving the request.

13. The apparatus of claim 1, wherein the wireless device comprises a second PRU.

14. The apparatus of claim 1, wherein at least one of the first network node or the second network node comprises a location management function (LMF).

15. The apparatus of claim 1, wherein the set of positioning signals comprises at least one of a positioning reference signal (PRS) or a sounding reference signal (SRS).

16. The apparatus of claim 1, wherein the at least one processor is further configured to:
transmit a second set of positioning signals to at least one of the UE, the first network node, or a second PRU; and
transmit, for at least one the first network node or the second network node, a second PRU assistance information associated with the second set of positioning signals.

17. The apparatus of claim 16, wherein the second set of positioning signals comprises at least one of a positioning reference signal (PRS) or a sounding reference signal (SRS).

18. The apparatus of claim 16, wherein the second PRU assistance information comprises at least one of:
a first indication of a location of at least one PRU;
a second indication of a beam angle associated with the second set of positioning signals;
a third indication of an antenna orientation associated with transmitting the second set of positioning signals;
a fourth indication of a group delay associated with the second set of positioning signals;
a fifth indication of a synchronization error associated with the second set of positioning signals;
a sixth indication of a timing error associated with the second set of positioning signals; or
a seventh indication of a clock drift range associated with the second set of positioning signals.

19. An apparatus for wireless communication at a user equipment (UE), comprising:
a memory; and
at least one processor coupled to the memory and, based at least in part on information stored in the memory, the at least one processor is configured to:
transmit a set of sounding reference signals (SRSs) for a positioning reference unit (PRU); and
receive, from a network node, a PRU label assistance report comprising a set of positioning measurements based on the set of SRSs and comprising PRU assistance information associated with the set of positioning measurements.

20. The apparatus of claim 19, wherein the PRU assistance information comprises at least one of:
a first indication of a location of at least one PRU;
a second indication of a beam angle associated with the set of SRSs;
a third indication of an antenna orientation associated with receiving the set of SRSs;
a fourth indication of a group delay associated with the set of positioning measurements;
a fifth indication of a sensor measurement associated with the set of positioning measurements;
a sixth indication of a sensor type associated with at least one PRU;
a seventh indication of a synchronization error associated with the set of positioning measurements;
an eighth indication of a timing error associated with the set of positioning measurements; or
a ninth indication of a clock drift range associated with the set of positioning measurements.

21. The apparatus of claim 19, further comprising a transceiver coupled to the at least one processor, wherein, to receive the PRU label assistance report from the network node, the at least one processor is configured to:
receive, via the transceiver, an assistance exchange message comprising the PRU label assistance report.

22. The apparatus of claim 19, wherein, to receive the PRU label assistance report from the network node, the at least one processor is configured to:
receive a long term evolution (LTE) positioning protocol (LPP) annex (LPPa) message comprising the PRU label assistance report.

23. The apparatus of claim 19, wherein the at least one processor is further configured to:
transmit a request to transmit the PRU label assistance report to the network node.

24. The apparatus of claim 23, wherein, to transmit the request, the at least one processor is configured to:
transmit an assistance exchange message comprising the request.

25. The apparatus of claim 19, wherein the at least one processor is further configured to:
transmit a request to configure a set of SRS resources to the network node; and
receive a configuration of the set of SRS resources from the network node, wherein, to transmit the set of SRSs to the PRU, the at least one processor is configured to transmit the set of SRSs based on the set of SRS resources.

26. The apparatus of claim 19, wherein the at least one processor is further configured to:
receive a set of positioning reference signal (PRSs) from the PRU;
measure the set of PRSs; and
calculate a position of the UE based on the measured set of PRSs and the set of positioning measurements.

27. The apparatus of claim 26, wherein the at least one processor is further configured to:
receive, from the network node, a second PRU assistance information associated with the set of PRSs, wherein, to calculate the position of the UE, the at least one processor is configured to calculate the position of the UE further based on the second PRU assistance information.

28. The apparatus of claim 27, wherein the second PRU assistance information comprises at least one of:
a first indication of a location of at least one PRU;
a second indication of a beam angle associated with the set of PRSs;
a third indication of an antenna orientation associated with transmitting the set of PRSs;
a fourth indication of a group delay associated with the set of PRSs;
a fifth indication of a synchronization error associated with the set of PRSs;
a sixth indication of a timing error associated with the set of PRSs; or
a seventh indication of a clock drift range associated with the set of PRSs.

29. A method of wireless communication at a wireless device, comprising:
receiving a set of positioning signals from at least one of a user equipment (UE), a first network node, or a positioning reference unit (PRU);
measuring the set of positioning signals; and
transmitting, for the first network node or a second network node, a PRU label assistance report comprising a set of positioning measurements based on the measured set of positioning signals and comprising PRU assistance information associated with measuring the set of positioning signals.

30. A method of wireless communication at a user equipment (UE), comprising:
transmitting a set of sounding reference signals (SRSs) for a positioning reference unit (PRU); and
receiving, from a network node, a PRU label assistance report comprising a set of positioning measurements based on the set of SRSs and comprising PRU assistance information associated with the set of positioning measurements.
